(19) United States
(12) Patent Application Publication
(10) Pub. No.: US 2021/0192469 A1
(43) Pub. Date: Jun. 24, 2021

(54) BUILDING CONTROL SYSTEM WITH PEER ANALYSIS FOR PREDICTIVE MODELS

(71) Applicant: Johnson Controls Technology Company, Auburn Hills, MI (US)

(72) Inventors: ROBERT D. TURNEY, Watertown, WI (US); MICHAEL J. WENZEL, Oak Creek, WI (US); MOHAMMAD N. ELBSAT, Milwaukee, WI (US); ANAS W. I. ALANQAR, Milwaukee, WI (US)

(73) Assignee: Johnson Controls Technology Company, Auburn Hills, MI (US)

(21) Appl. No.: 16/719,533

(22) Filed: Dec. 18, 2019

(51) Int. Cl. G06Q 10/00; G06N 5/02; G06N 20/00; G05B 19/042

(52) U.S. Cl. CPC G06Q 10/20; G06N 5/02; G05B 2219/25011; G05B 19/042; G06N 20/00

(57) ABSTRACT

A controller for performing a peer analysis of a predictive model for a building including processors and non-transitory computer-readable media storing instructions that, when executed by the processors, cause the processors to perform operations. The operations include comparing model parameters of a set of predictive models corresponding to a set of building zones, the model parameters indicating system dynamics of the building zones, to determine whether any of the building zones are exhibiting abnormal system dynamics. The operations include initiating a corrective action in response to determining that at least one of the building zones is exhibiting abnormal system dynamics.

### BACKGROUND

The present disclosure relates generally to control systems for buildings. The present disclosure relates more particularly to determining accuracy of models for control systems.

System identification refers to the determination of a model that describes a system. For example, system identification may be used to identify a system describing environmental conditions. Because the physical phenomena that govern such systems are often complex, nonlinear, and poorly understood, system identification requires the determination of model parameters based on measured and recorded data from the real system in order to generate an accurate predictive model. However, if accuracy of the predictive model is not maintained, control systems and other system utilizing the predictive model may be jeopardized.

### SUMMARY

One implementation of the present disclosure is a controller for performing a peer analysis of predictive models for a building, according to some embodiments. The controller includes one or more processors, according to some embodiments. The controller includes one or more non-transitory computer-readable media storing instructions that, when executed by the one or more processors, cause the one or more processors to perform operations, according to some embodiments. The operations include comparing model parameters of a set of predictive models corresponding to a set of building zones, the model parameters indicating system dynamics of the building zones, to determine whether any of the building zones are exhibiting abnormal system dynamics, according to some embodiments. The operations include initiating a corrective action in response to determining that at least one of the building zones is exhibiting abnormal system dynamics, according to some embodiments.

In some embodiments, initiating the corrective action includes determining whether a source of abnormal system dynamics of the at least one zone can be identified in at least one predictive model of the set of predictive models. Initiating the correction action includes, in response to a determination that the source of abnormal system dynamics of the at least one zone can be identified in the at least one predictive model, identifying the source of abnormal system dynamics, according to some embodiments. The corrective action is selected based on the source of abnormal system dynamics, according to some embodiments.

In some embodiments, the set of predictive models is generated using a system identification process based on training data to identify predictive models.

In some embodiments, comparing model parameters of the set of predictive models includes at least one of performing a multivariate outlier analysis on the model parameters or determining whether the model parameters adhere to a threshold value based on a second building with similar characteristics to the building.

In some embodiments, initiating the corrective action includes determining the corrective action based on which of the system dynamics are associated with the model parameter. Initiating the corrective action includes generating corrective action instructions indicating how to perform the corrective action, according to some embodiments. Initiating the corrective action includes initiating the corrective action by providing the corrective action instructions to one or more entities, according to some embodiments.

In some embodiments, the controller includes a database configured to store predictive models for buildings or building spaces. The operations further include querying the database to obtain the set of predictive models, according to some embodiments.

In some embodiments, the corrective action includes at least one of providing an alert to a user, scheduling a maintenance activity for building equipment, purchasing new building equipment, generating control actions for the building equipment, or initiating a system identification experiment to gather training data.

Another implementation of the present disclosure is a method for performing a peer analysis of predictive models for a building, according to some embodiments. The method includes comparing model parameters of a set of predictive models corresponding to a set of building zones, the model parameters indicating system dynamics of the building zones, to determine whether any of the building zones are exhibiting abnormal system dynamics, according to some embodiments. The method includes initiating a corrective action in response to determining that at least one of the building zones is exhibiting abnormal system dynamics, according to some embodiments.

In some embodiments, initiating the corrective action includes determining whether a source of abnormal system dynamics of the at least one zone can be identified in at least one predictive model of the set of predictive models. Initiating the corrective action includes, in response to a determination that the source of abnormal system dynamics of the at least one zone can be identified in the at least one predictive model, identifying the source of abnormal system dynamics, according to some embodiments. The corrective action is selected based on the source of abnormal system dynamics, according to some embodiments.

In some embodiments, the set of predictive models is generated using a system identification process based on training data to identify predictive models.

In some embodiments, comparing model parameters of the set of predictive models includes at least one of performing a multivariate outlier analysis on the model parameters or determining whether the model parameters adhere to a threshold value based on a second building with similar characteristics to the building.

In some embodiments, initiating the corrective action includes determining the corrective action based on which of the system dynamics are associated with the model parameter. Initiating the corrective action includes generating corrective action instructions indicating how to perform the corrective action, according to some embodiments. Initiating the corrective action includes initiating the corrective action by providing the corrective action instructions to one or more entities, according to some embodiments.

In some embodiments, the method includes querying a database to obtain the set of predictive models. The database stores predictive models for buildings or building spaces, according to some embodiments.

In some embodiments, the corrective action includes at least one of providing an alert to a user, scheduling a maintenance activity for building equipment, purchasing new building equipment, generating control actions for the building equipment, or initiating a system identification experiment to gather training data.

Another implementation of the present disclosure is an environmental control system for a building, according to some embodiments. The system includes building equipment that operates to affect a variable state or condition of the building, according to some embodiments. The system includes a controller including a processing circuit configured to perform operations, according to some embodiments. The operations include comparing model parameters of a set of predictive models corresponding to a set of building zones, the model parameters indicating system dynamics of the building zones, to determine whether any of the building zones are exhibiting abnormal system dynamics, according to some embodiments. The operations include initiating a corrective action in response to determining that at least one of the building zones is exhibiting abnormal system dynamics, according to some embodiments.

In some embodiments, initiating the corrective action includes determining whether a source of abnormal system dynamics of the at least one zone can be identified in at least one predictive model of the set of predictive models. Initiating the correction action includes, in response to a determination that the source of abnormal system dynamics of the at least one zone can be identified in the at least one predictive model, identifying the source of abnormal system dynamics, according to some embodiments. The corrective action is selected based on the source of abnormal system dynamics, according to some embodiments.

In some embodiments, the set of predictive models is generated using a system identification process based on training data to identify predictive models.

In some embodiments, comparing model parameters of the set of predictive models includes at least one of performing a multivariate outlier analysis on the model parameters or determining whether the model parameters adhere to a threshold value based on a second building with similar characteristics to the building.

In some embodiments, initiating the corrective action includes determining the corrective action based on which of the system dynamics are associated with the model parameter. Initiating the corrective action includes generating corrective action instructions indicating how to perform the corrective action, according to some embodiments. Initiating the corrective action includes initiating the corrective action by providing the corrective action instructions to one or more entities, according to some embodiments.

In some embodiments, the corrective action includes at least one of providing an alert to a user, scheduling a maintenance activity for the building equipment, purchasing new building equipment, generating control actions for the building equipment, or initiating a system identification experiment to gather training data.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE FIGURES

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to some embodiments.

FIG. 2 is a block diagram of the building and HVAC system of FIG. 1, according to some embodiments.

FIG. 3 is a circuit-style diagram of a model of the building and HVAC system of FIG. 1, according to some embodiments.

FIG. 4 is a block diagram of a controller for use with the HVAC system of FIG. 1, according to some embodiments.

FIG. 5 is a detailed block diagram of a model identifier of the controller of FIG. 4, according to some embodiments.

FIG. 6 is flowchart of a process for system identification, according to some embodiments.

FIG. 7 is a flowchart of a multi-step ahead prediction error method for use in system identification, according to some embodiments.

FIG. 8 is a visualization useful in illustrating the multi-step ahead prediction error method of FIG. 7, according to some embodiments.

FIG. 9A is a first illustration of a variable refrigerant flow system for a building, according to some embodiments.

FIG. 9B is a second illustration of a variable refrigerant flow system for a building, according to some embodiments.

FIG. 10 is a detailed diagram of a variable refrigerant flow system for a building, according to some embodiments.

FIG. 11 is a block diagram of the building and HVAC system of FIG. 1 including a peer analysis controller, according to some embodiments.

FIG. 12 is a block diagram of the peer analysis controller of FIG. 11 including a model parameter comparator and a corrective action instruction generator, according to some embodiments.

FIG. 13 is a block diagram of the model parameter comparator of FIG. 12 in greater detail, according to some embodiments.

FIG. 14 is a block diagram of the correction action instruction generator of FIG. 12 in greater detail, according to some embodiments.

FIG. 15 is a flow diagram of a process for performing a peer analysis to determine if a predictive model is accurate, according to some embodiments.

### DETAILED DESCRIPTION

Referring generally to the FIGURES, systems and methods for performing a peer analysis of a predictive model are shown, according to some embodiments. Peer analysis of the predictive model can include comparing model parameters of the predictive model to expected values and/or to comparison models. Expected values can be values that the model parameters should be approximately equal to if the predictive model accurately models an associated system. In some embodiments, the expected values are determined based on the comparison models. Comparison models can be other predictive models that model systems similar to the system associated with the predictive model.

If systems are similar, their respective models should have model parameters that are approximately equivalent. Of course, there may be some expected deviation between model parameters, however the model parameters of each model can be compared to determine model accuracy. If model parameters of the predictive model in question differ significantly from model parameters of the comparison models, the predictive model may be determined to not accurately model system dynamics of the associated system. Alternatively or additionally, comparisons of model parameters can be used to identify zones (or other spaces) of a building that are behaving abnormally. Specifically, if a particular predictive model associated with a particular zone includes model parameters that are significantly different than model parameters of the other predictive models in the comparison, the particular zone may be identified to be behaving abnormally as its associated predictive model is inconsistent with expectations. In this case, abnormal behavior may be defined by system dynamics (e.g., temperature dynamics) of the zone being inconsistent with similar zones. Advantageously, peer analysis of model parameters can reduce and/or eliminate an amount of time that inaccurate predictive models are utilized.

If the predictive model is determined to be accurate, the predictive model can be used in various applications such as control-based applications (e.g., model predictive control). If the predictive model is determined to not be accurate, a corrective action can be initiated to address the inaccuracy. Corrective actions can include various actions that address the inaccuracy of the predictive model. For example, corrective actions can include performing a new system identification experiment, alerting a user to the inaccuracy, repairing existing building equipment, etc. Based on initiation of a corrective action, the corrective action can be performed in order to address the model inaccuracy. These and other features of peer analysis for predictive models are discussed in greater detail below.

### Building HVAC Systems

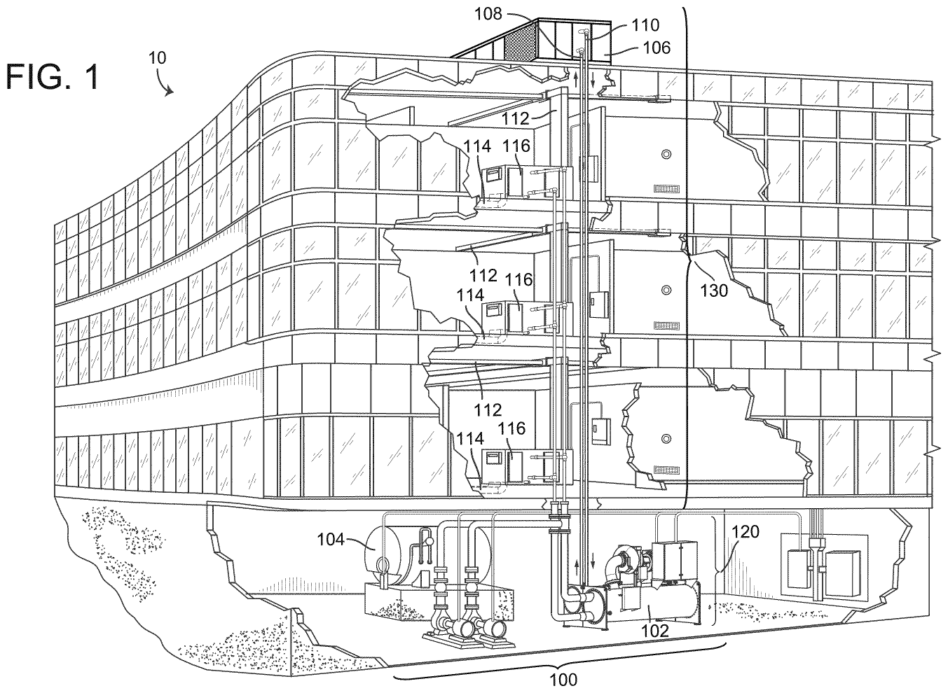

Referring to FIG. 1, a perspective view of a building 10 is shown. Building 10 is served by a building management system (BMS). A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

HVAC system 100 thereby provides heating and cooling to the building 10. The building 10 also includes other sources of heat transfer that the indoor air temperature in the building 10. The building mass (e.g., walls, floors, furniture) influences the indoor air temperature in building 10 by storing or transferring heat (e.g., if the indoor air temperature is less than the temperature of the building mass, heat transfers from the building mass to the indoor air). People, electronic devices, other appliances, etc. (“heat load”) also contribute heat to the building 10 through body heat, electrical resistance, etc. Additionally, the outside air temperature impacts the temperature in the building 10 by providing heat to or drawing heat from the building 10.

### HVAC System and Model

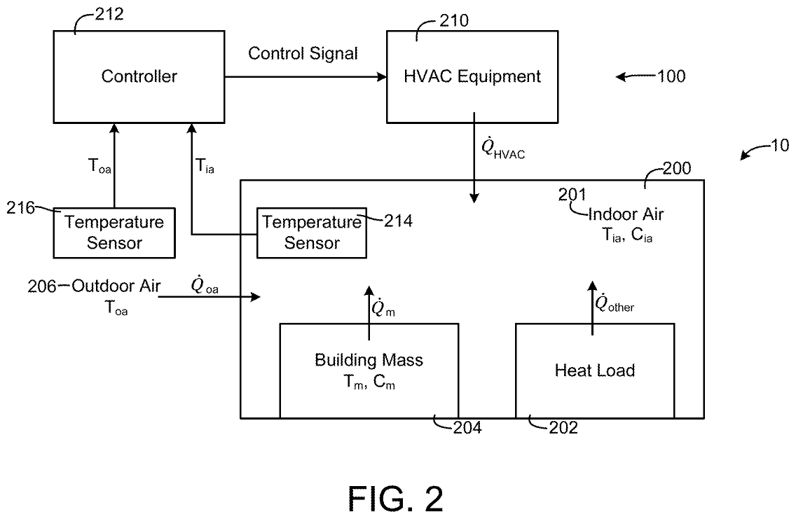

Referring now to FIG. 2, a block diagram of the HVAC system 100 with building 10 is shown, according to an exemplary embodiment. More particularly, FIG. 2 illustrates the variety of heat transfers that affect the indoor air temperature Tᵢₐ of the indoor air 201 in zone 200 of building 10. Zone 200 is a room, floor, area, etc. of building 10. In general, the primary goal of the HVAC system 100 is to maintain the indoor air temperature Tᵢₐ the zone 200 at or around a desired temperature to facilitate the comfort of occupants of the zone 200 or to meet other needs of the zone 200.

As shown in FIG. 2, the indoor air temperature Tᵢₐ of the zone 200 has a thermal capacitance Cᵢₐ. The indoor air temperature Tᵢₐ is affected by a variety of heat transfers \dot{Q} into the zone 200, as described in detail below. It should be understood that although all heat transfers \dot{Q} are shown in FIG. 2 as directed into the zone 200, the value of one or more of the heat transfers \dot{Q} may be negative, such that heat flows out of the zone 200.

The heat load 202 contributes other heat transfer \dot{Q}ₒₜₕₑᵣ to the zone 200. The heat load 202 includes the heat added to the zone by occupants (e.g., people, animals) that give off body heat in the zone 200. The heat load 202 also includes computers, lighting, and other electronic devices in the zone 200 that generate heat through electrical resistance, as well as solar irradiance.

The building mass 204 contributes building mass heat transfer \dot{Q}ₘ to the zone 200. The building mass 204 includes the physical structures in the building, such as walls, floors, ceilings, furniture, etc., all of which can absorb or give off heat. The building mass 204 has a temperature Tₘ and a lumped mass thermal capacitance Cₘ. The resistance of the building mass 204 to exchange heat with the indoor air 201 (e.g., due to insulation, thickness/layers of materials, etc.) may be characterized as mass thermal resistance Rₘᵢ.

The outdoor air 206 contributes outside air heat transfer \dot{Q}ₒₐ to the zone 200. The outdoor air 206 is the air outside of the building 10 with outdoor air temperature Tₒₐ. The outdoor air temperature Tₒₐ fluctuates with the weather and climate. Barriers between the outdoor air 206 and the indoor air 201 (e.g., walls, closed windows, insulation) create an outdoor-indoor thermal resistance Rₒᵢ to heat exchange between the outdoor air 206 and the indoor air 201.

The HVAC system 100 also contributes heat to the zone 200, denoted as \dot{Q}_{HVAC}. The HVAC system 100 includes HVAC equipment 210, controller 212, an indoor air temperature sensor 214 and an outdoor air temperature sensor 216. The HVAC equipment 210 may include the waterside system 120 and airside system 130 of FIG. 1, or other suitable equipment for controllably supplying heating and/or cooling to the zone 200. In general, HVAC equipment 210 is controlled by a controller 212 to provide heating (e.g., positive value of \dot{Q}_{HVAC}) or cooling (e.g., a negative value of \dot{Q}_{HVAC}) to the zone 200.

The indoor air temperature sensor 214 is located in the zone 200, measures the indoor air temperature Tᵢₐ, and provides the measurement of Tᵢₐ to the controller 212. The outdoor air temperature sensor 216 is located outside of the building 10, measures the outdoor air temperature Tₒₐ, and provides the measurement of Tₒₐ to the controller 212.

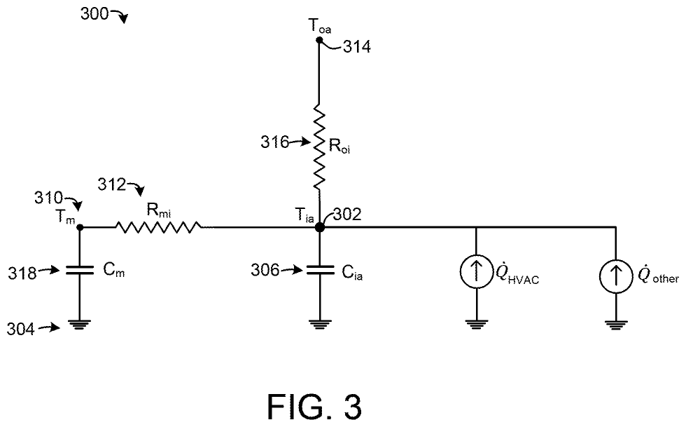

The controller 212 receives the temperature measurements Tₒₐ and Tᵢₐ, generates a control signal for the HVAC equipment 210, and transmits the control signal to the HVAC equipment 210. The operation of the controller 212 is discussed in detail below. In general, the controller 212 considers the effects of the heat load 202, building mass 204, and outdoor air 206 on the indoor air 201 in controlling the HVAC equipment 210 to provide a suitable level of \dot{Q}_{HVAC}. A model of this system for use by the controller 212 is described with reference to FIG. 3.

In the embodiments described herein, the control signal provide to the HVAC equipment 210 by the controller 110 indicates a temperature setpoint Tₛₚ for the zone 200. To determine the temperature setpoint Tₛₚ, the controller 212 assumes that the relationship between the indoor air temperature Tᵢₐ and the temperature setpoint Tₛₚ follows a proportional-integral control law with saturation, represented as:

\dot{Q}_{HVAC,j}=K_{p,j}εₛₚ+K_{l,j} ∫₀^{t}εₛₚ(s)ds (Eq. A)

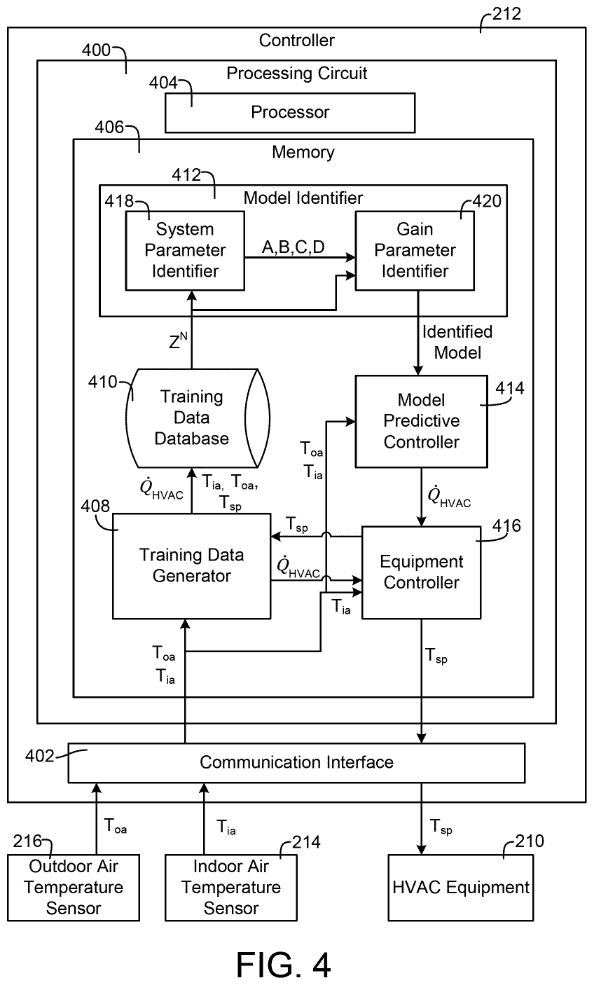

εₛₚ=T_{sp,j}−Tᵢₐ (Eq. B)

where j ∈ {clg, hlg} is the index that is used to denote either heating or cooling mode. Different parameters K_{p,j} and K_{l,j} are needed for the heating and cooling mode. Moreover, the heating and cooling load is constrained to the following set: \dot{Q}_{HVAC,j} ∈ [0, \dot{Q}_{clg,max}] for cooling mode (j=clg) and \dot{Q}_{HVAC,j} ∈ [−\dot{Q}_{htg,max}, 0] for heating mode (j=htg). As discussed in detail below with reference to FIG. 4, the controller 212 uses this model in generating a control signal for the HVAC equipment 210.

Referring now to FIG. 3, a circuit-style diagram 300 corresponding to the zone 200 and the various heat transfers \dot{Q} of FIG. 2 is shown, according to an exemplary embodiment. In general, the diagram 300 models the zone 200 as a two thermal resistance, two thermal capacitance, control-oriented thermal mass system. This model can be characterized by the following system of linear differential equations, described with reference to FIG. 3 below:

$$\begin{matrix}{C}_{ia} {\dot{T}}_{ia} = \frac{1}{{R}_{mi}} ( {T}_{m} - {T}_{ia} ) + \frac{1}{{R}_{oi}} ( {T}_{oa} - {T}_{ia} ) - {\dot{Q}}_{HVAC} + {\dot{Q}}_{other} & ( Eq . C ) \\ {C}_{m} {\dot{T}}_{m} = \frac{1}{{R}_{mi}} ( {T}_{ia} - {T}_{m} ) & ( Eq . D )\end{matrix}$$

where the first line (Eq. C) focuses on the indoor air temperature Tᵢₐ, and each term in Eq. C corresponds to a branch of diagram 300 as explained below:

Indoor air node 302 corresponds to the indoor air temperature Tᵢₐ. From indoor air node 302, the model branches in several directions, including down to a ground 304 via a capacitor 306 with a capacitance Cᵢₐ. The capacitor 306 models the ability of the indoor air to absorb or release heat and is associated with the rate of change of the indoor heat transfer \dot{T}ᵢₐ. Accordingly, the capacitor 306 enters Eq. C on the left side of the equation as Cᵢₐ\dot{T}ᵢₐ.

From indoor air node 302, the diagram 300 also branches left to building mass node 310, which corresponds to the thermal mass temperature Tₘ. A resistor 312 with mass thermal resistance Rₘᵢ separates the indoor air node 302 and the building mass node 310, modeling the heat transfer \dot{Q}ₘ from the building mass 204 to the indoor air 201 as

$$\frac{1}{{R}_{mi}} ( {T}_{m} - {T}_{ia} ) .$$

This term is included on the right side of Eq. C above as contributing to the rate of change of the indoor air temperature \dot{T}ᵢₐ.

The diagram 300 also branches up from indoor air node 302 to outdoor air node 314. A resistor 316 with outdoor-indoor thermal resistance Rₒᵢ separates the indoor air node 302 and the outdoor air node 314, modeling the flow heat from the outdoor air 206 to the indoor air 201 as

$$\frac{1}{{R}_{oi}} ( {T}_{oa} - {T}_{ia} ) .$$

This term is also included on the right side of Eq. C above as contributing to the rate of change of the indoor air temperature \dot{T}ᵢₐ.

Also from indoor air node 302, the diagram 300 branches right to two \dot{Q} sources, namely \dot{Q}_{HVAC} and \dot{Q}ₒₜₕₑᵣ. As mentioned above, \dot{Q}ₒₜₕₑᵣ corresponds to heat load 202 and to a variety of sources of energy that contribute to the changes in the indoor air temperature Tᵢₐ. \dot{Q}ₒₜₕₑᵣ is not measured or controlled by the HVAC system 100, yet contributes to the rate of change of the indoor air temperature \dot{T}ᵢₐ. \dot{Q}_{HVAC} is generated and controlled by the HVAC system 100 to manage the indoor air temperature Tᵢₐ. Accordingly, \dot{Q}_{HVAC} and \dot{Q}ₒₜₕₑᵣ are included on the right side of Eq. C above.

The second nonlinear differential equation (Eq. D) above focuses on the rate of change \dot{T}ₘ in the building mass temperature T. The capacity of the building mass to receive or give off heat is modelled by capacitor 318. Capacitor 318 has lumped mass thermal capacitance Cₘ and is positioned between a ground 304 and the building mass node 310 and regulates the rate of change in the building mass temperature Tₘ. Accordingly, the capacitance Cₘ is included on left side of Eq. D. Also branching from the building mass node 310 is resistor 312 leading to indoor air node 302. As mentioned above, this branch accounts for heat transfer \dot{Q}ₘ between the building mass 204 and the indoor air 201. Accordingly, the term

$$\frac{1}{{R}_{mi}} ( {T}_{ia} - {T}_{m} )$$

is included on the right side of Eq. D.

As described in detail below, the model represented by diagram 300 is used by the controller 212 in generating a control signal for the HVAC equipment 210. More particularly, the controller 212 uses a state-space representation of the model shown in diagram 300. The state-space representation used by the controller 212 can be derived by incorporating Eq. A and B with Eq. C and D, and writing the resulting system of equations as a linear system of differential equations to get:

$$\begin{matrix}[ \begin{matrix}{\dot{T}}_{ia} \\ {\dot{T}}_{m} \\ \dot{I}\end{matrix} ] = [ \begin{matrix}\frac{1}{{C}_{ia}} ( {K}_{p , j} - \frac{1}{{R}_{mi}} - \frac{1}{{R}_{oi}} ) & \frac{1}{{C}_{ia} {R}_{mi}} & \frac{{K}_{I , j}}{{C}_{ia}} \\ \frac{1}{{C}_{m} {R}_{mi}} & - \frac{1}{{C}_{m} {R}_{mi}} & 0 \\ - 1 & 0 & 0\end{matrix} ] [ \begin{matrix}{T}_{ia} \\ {T}_{m} \\ I\end{matrix} ] + [ \begin{matrix}- \frac{{K}_{p , j}}{{C}_{ia}} & \frac{1}{{C}_{ia} {R}_{oi}} \\ 0 & 0 \\ 1 & 0\end{matrix} ] [ \begin{matrix}{T}_{spj} \\ {T}_{oa}\end{matrix} ] + [ \begin{matrix}\frac{1}{{C}_{ia}} \\ 0 \\ 0\end{matrix} ] {\dot{Q}}_{other} ; & ( Eq . E ) \\ [ \begin{matrix}{T}_{ia} \\ {\dot{Q}}_{HVAC , j}\end{matrix} ] = [ \begin{matrix}1 & 0 & 0 \\ - {K}_{p , j} & 0 & {K}_{I , j}\end{matrix} ] [ \begin{matrix}{T}_{ia} \\ {T}_{m} \\ I\end{matrix} ] + [ \begin{matrix}0 & 0 \\ {K}_{p , j} & 0\end{matrix} ] [ \begin{matrix}{T}_{sp , j} \\ {T}_{oa}\end{matrix} ] & ( Eq . F )\end{matrix}$$

where I represents the integral term ∫₀^{t} εₛₚ(s) ds from Eq. A. The resulting linear system has three states (Tᵢₐ, Tₘ, I), two inputs (T_{sp, j}, Tₒₐ), two outputs (Tᵢₐ, \dot{Q}_{HVAC}), and one disturbance \dot{Q}ₒₜₕₑᵣ. Because \dot{Q}ₒₜₕₑᵣ is not measured or controlled, the controller 212 models the disturbance \dot{Q}ₒₜₕₑᵣ using an input disturbance model that adds a forth state d to the state space representation. In a more compact form, this linear system of differential equations can be written as:

$$\begin{matrix} \dot{x} ( t ) = {A}_{c} ( θ ) x ( t ) + {B}_{c} ( θ ) u ( t ) ; & ( Eq . G ) \\ y ( t ) = {C}_{c} ( θ ) x ( t ) + {D}_{c} ( θ ) u ( t ) ; \\ where \\ {A}_{c} ( θ ) = [ \begin{matrix}- ( {θ}_{1} + {θ}_{2} + {θ}_{3} {θ}_{4} ) & {θ}_{2} & {θ}_{3} {θ}_{4} {θ}_{5} \\ {θ}_{6} & - {θ}_{6} & 0 \\ - 1 & 0 & 0\end{matrix} ] , {B}_{c} ( θ ) = [ \begin{matrix}{θ}_{3} {θ}_{4} & {θ}_{1} \\ 0 & 0 \\ 1 & 0\end{matrix} ] , {C}_{c} ( θ ) = [ \begin{matrix}1 & 0 & 0 \\ - {θ}_{4} & 0 & {θ}_{5} {θ}_{4}\end{matrix} ] , {D}_{c} ( θ ) = [ \begin{matrix}0 & 0 \\ {θ}_{4} & 0\end{matrix} ] ; \\ {θ}_{1} = \frac{1}{{C}_{ia} {R}_{oi}} ; {θ}_{2} = \frac{1}{{C}_{ia} {R}_{mi}} ; {θ}_{3} = \frac{1}{{C}_{ia}} ; {θ}_{4} = {K}_{p} ; {θ}_{5} = \frac{1}{τ} ; {θ}_{6} = \frac{1}{{C}_{m} {R}_{mi}} ; and \\ \dot{x} ( t ) = [ \begin{matrix}{\dot{T}}_{ia} \\ {\dot{T}}_{m} \\ \dot{I}\end{matrix} ] ; x ( t ) = [ \begin{matrix}{T}_{ia} \\ {T}_{m} \\ I\end{matrix} ] ; u ( t ) = [ \begin{matrix}{T}_{spj} \\ {T}_{oa}\end{matrix} ] . & ( Eq . H )\end{matrix}$$

As described in detail below, the controller 212 uses a two-step process to parameterize the system. In the first step, the controller 212 identifies the system parameters θ={θ₁, θ₂, θ₃, θ₄, θ₅, θ₆} (i.e., the values of Cᵢₐ, Cₘ, Rₘᵢ, Rₒᵢ, K_{p,j}, K_{i,j}). The disturbance state d is then introduced into the model and an Kalman estimator gain is added, such that in the second step the controller 212 identifies the Kalman gain parameters K.

As used herein, the term ‘variable’ refers to an item/quantity capable of varying in value over time or with respect to change in some other variable. A “value” as used herein is an instance of that variable at a particular time. A value may be measured or predicted. For example, the temperature setpoint Tₛₚ is a variable that changes over time, while Tₛₚ(3) is a value that denotes the setpoint at time step 3 (e.g., 68 degrees Fahrenheit). The term “predicted value” as used herein describes a quantity for a particular time step that may vary as a function of one or more parameters.

Controller for HVAC Equipment with System Identification

Referring now to FIG. 4, a detailed diagram of the controller 212 is shown, according to an exemplary embodiment. The controller 212 includes a processing circuit 400 and a communication interface 402. The communication interface 402 is structured to facilitate the exchange of communications (e.g., data, control signals) between the processing circuit 400 and other components of HVAC system 100. As shown in FIG. 4, the communication interface 402 facilitates communication between the processing circuit 400 and the outdoor air temperature sensor 216 and the indoor air temperature sensor 214 to all temperature measurements Toa and Tia to be received by the processing circuit 400. The communication interface 402 also facilitates communication between the processing circuit 400 and the HVAC equipment 210 that allows a control signal (indicated as temperature setpoint Tₛₚ) to be transmitted from the processing circuit 400 to the HVAC equipment 210.

The processing circuit 400 is structured to carry out the functions of the controller described herein. The processing circuit 400 includes a processor 404 and a memory 406. The processor 404 may be implemented as a general-purpose processor, an application-specific integrated circuit, one or more field programmable gate arrays, a digital signal processor, a group of processing components, or other suitable electronic processing components. The memory 406, described in detail below, includes one or more memory devices (e.g., RAM, ROM, NVRAM, Flash Memory, hard disk storage) that store data and/or computer code for facilitating at least some of the processes described herein. For example, the memory 406 stores programming logic that, when executed by the processor 404, controls the operation of the controller 212. More particularly, the memory 406 includes a training data generator 408, a training data database 410, a model identifier 412, a model predictive controller 414, and an equipment controller 416. The various generators, databases, identifiers, controllers, etc. of memory 406 may be implemented as any combination of hardware components and machine-readable media included with memory 406.

The equipment controller 416 is configured to generate a temperature setpoint Tsp that serves as a control signal for the HVAC equipment 210. The equipment controller receives inputs of the indoor air temperature Tᵢₐ from the indoor air temperature sensor 214 via the communication interface 402 and \dot{Q}_{HVAC} from the model predictive controller 414 (during normal operation) and the training data generator 408 (during a training data generation phase described in detail below). The equipment controller uses Tᵢₐ and \dot{Q}_{HVAC} to generate Tₛₚ by solving Eq. A and Eq. B above for Tₛₚ. The equipment controller 416 then provides the control signal Tₛₚ to the HVAC equipment 210 via the communication interface 402.

The model predictive controller 414 determines \dot{Q}_{HVAC} based on an identified model and the temperature measurements Tᵢₐ, Tₒₐ, and provides \dot{Q}_{HVAC} to the equipment controller 416. The model predictive controller 414 follows a model predictive control (MPC) approach. The MPC approach involves predicting future system states based on a model of the system, and using those predictions to determine the controllable input to the system (here, \dot{Q}_{HVAC}) that bests achieves a control goal (e.g., to maintain the indoor air temperature near a desired temperature). A more accurate model allows the MPC to provide better control based on more accurate predictions. Because the physical phenomena that define the behavior of the system (i.e., of the indoor air 201 in the building 10) are complex, nonlinear, and/or poorly understood, a perfect model derived from first-principles is generally unachievable or unworkable. Thus, the model predictive controller 414 uses a model identified through a system identification process facilitated by the training data generator 408, the training data database 410, and the model identifier 412, described in detail below.

System identification, as facilitated by the training data generator 408, the training data database 410, and the model identifier 412, is a process of constructing mathematical models of dynamic systems. System identification provides a suitable alternative to first-principles-derived model when first principles models are unavailable or too complex for on-line MPC computations. System identification captures the important and relevant system dynamics based on actual input/output data (training data) of the system, in particular by determining model parameters particular to a building or zone to tune the model to the behavior of the building/zone. As described in detail below, the training data generator 408, the training data database 410, and the model identifier 412 each contribute to system identification by the controller 212.

The training data generator 408 is configured to generate training data by providing an excitation signal to the system. That is, the training data generator provides various \dot{Q}_{HVAC} values to the equipment controller 416 for a number N of time steps k, and receives the measured output response of the indoor air temperature La at each time step k from the air temperature sensor 214. The various \dot{Q}_{HVAC} values may be chosen by the training data generator 408 to explore the system dynamics as much as possible (e.g., across a full range of possible \dot{Q}_{HVAC} values, different patterns of \dot{Q}_{HVAC} values, etc.).

The equipment controller 416 receives the various \dot{Q}_{HVAC} values and generates various control inputs Tₛₚ in response. The temperature setpoint Tₛₚ for each time step k is provided to the HVAC equipment 210, which operates accordingly to heat or cool the zone 200 (i.e., to influence Tᵢₐ). The temperature setpoints Tₛₚ may also be provided to the training data generator 408 to be included in the training data. The training data generator receives an updated measurement of the indoor air temperature Tᵢₐ for each time step k and may also receive the outdoor air temperature Tₒₐ for each time step k. The training data generator 408 thereby causes the states, inputs, and outputs of the system to vary across the time steps k and generates data corresponding to the inputs and outputs.

The inputs and outputs generated by the training data generator 408 are provided to the training data database 410. More particularly, in the nomenclature of the model of Eq. E and Eq. F above, the training data generator 408 provides inputs Tₛₚ and Tₒₐ and outputs \dot{Q}_{HVAC} and Tᵢₐ for each time step k to the training data database 410.

The training data database 410 stores the inputs and outputs for each time step k provided by the training data generator 408. Each input and output is tagged with a time step identifier, so that data for the same time step can be associated together. The training data database 410 thereby collects and stores input and output data for each time step k, k=0, . . . , N, or, more specifically, Tₛₚ(k), Tₒₐ(k), Tᵢₐ(k), and \dot{Q}_{HVAC}(k), for k, k=0, . . . , N. This data is grouped together in the training data database 410 in a set of training data Z^{N}. In the notation of Eq. G and Eq. H, Z^{N}=[y(1), u(1), y(2), u(2), . . . , y(N), u(N)].

In some embodiments, the training data is refined using a saturation detection and removal process. System and methods for saturation detection and removal suitable for use to refine the training data Z^{N} are described in U.S. patent application Ser. No. 15/900,459, filed Feb. 20, 2018, incorporated by reference herein in its entirety. For example, as described in detail therein, the training data may be filtered by determining whether the operating capacity is in a non-transient region for a threshold amount of a time period upon determining that an error for the building zone exists for the time period, and in response to a determination that the operating capacity is in the non-transient region for at least the threshold amount of the time period, indicating the time period as a saturation period. Data from the saturation period can then be removed from the training data.

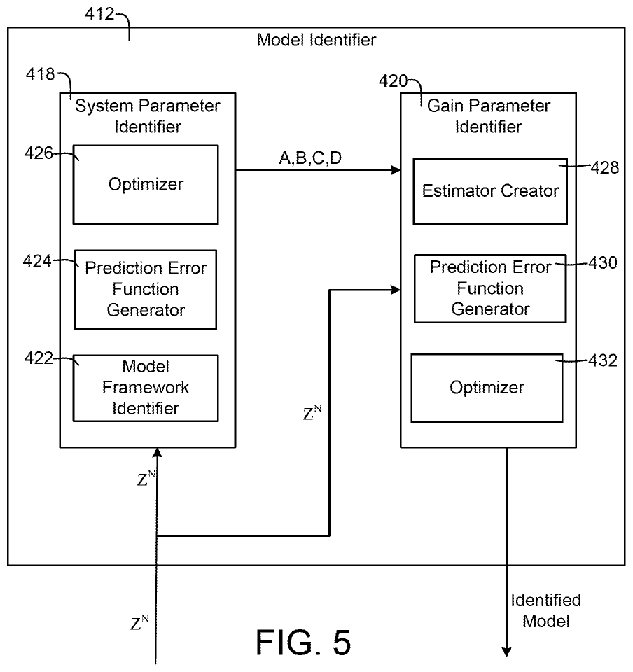

The model identifier 412 accesses the training data database 410 to retrieve the training data Z^{N} and uses the training data Z^{N} to identify a model of the system. The model identifier 412 includes a system parameter identifier 418 and a gain parameter identifier 420. As shown in detail in FIG. 5 and discussed in detail with reference thereto, the system parameter identifier 418 carries out a first step of system identification, namely identifying the model parameters, while the gain parameter identifier 420 carries out the second step, namely determining a Kalman gain estimator. The model parameters and the Kalman gain estimator are included in an identified model of the system, and that model is provided to the model predictive controller 414. The model predictive controller can thus facilitate the control of the HVAC equipment 210 as described above.

Referring now to FIG. 5, a detailed view of the model identifier 412 is shown, according to an exemplary embodiment. As mentioned above, the model identifier 412 includes the system parameter identifier 418 and the gain parameter identifier 420. The system parameter identifier 418 is structured to identify the matrices A, B, C, D of Eqs. G and H, i.e., the values of θ={θ₁, θ₂, θ₃, θ₄, θ₅, θ₆}. In the embodiment described herein, this corresponds to finding the values of Cᵢₐ, Cₘ, Rₘᵢ, Rₒᵢ, K_{p,j}, and K_{i,j}.

The system parameter identifier 418 includes a model framework identifier 422, a prediction error function generator 424, and an optimizer 426. The model framework identifier 422 identifies that the model of the system, denoted as [symbol] (θ), corresponds to the form described above in Eqs. G and H, i.e.,

\dot{x}(t)=A_{c}(θ)x(t)+B_{c}(θ)u(t); (Eq. G)

y(t)=C_{c}(θ)x(t)+D_{c}(θ)u(t); (Eq. H).

The model framework identifier 422 thereby determines that the system parameter identifier 418 has the goal of determining a parameter vector \hat{θ}_{N} from the set of θ ∈ [symbol] ⊂ [symbol] ^{d}, where [symbol] is the set of admissible model parameter values. The resulting possible models are given by the set: M={ [symbol] (θ), θ ∈ [symbol] }. The goal of the system parameter identifier 418 is to select a parameter vector \hat{θ}_{N} from among possible values of θ that best matches the model to the physical system (i.e., the vector θ is a list of variables and the vector \hat{θ}_{N} is a list of values), thereby defining matrices A, B, C, and D. The model framework identifier 422 also receives training data Z^{N} and sorts the training data (i.e., Tₛₚ(k), Tₒₐ(k), Tᵢₐ(k), and \dot{Q}_{HVAC}(k), for k, k=0, . . . , N) into the notation of Eq. G-H as input/output data Z^{N}=[y(1), u(1), y(2), u(2), . . . , y(N), u(N)].

The prediction error function generator 424 receives the model framework M={ [symbol] (θ), θ ∈ [symbol] } and the training data Z^{N} from the model framework identifier 422. The prediction error function generator 424 applies a prediction error method to determine the optimal parameter vector \hat{θ}_{N}. In general, prediction error methods determine the optimal parameter vector \hat{θ}_{N} by minimizing some prediction performance function V_{N}(θ, Z^{N}) that is based in some way on the difference between predicted outputs and the observed/measured outputs included in the training data Z^{N}. That is, the parameter estimation θ_{N} is determined as:

$${\hat{θ}}_{N} = {\hat{θ}}_{N} ( {Z}^{N} ) = arg {min}_{θ ∈ {D}_{ℳ}} {V}_{N} ( θ , {Z}^{N} ) .$$

The prediction error function generator 424 use one or more of several possible prediction error approaches to generate a prediction performance function V_{N}(θ, Z^{N}). In the embodiment shown, the prediction error function generator applies a simulation approach. In the simulation approach, the prediction error function generator 424 uses the model [symbol] (θ), the input trajectory [u(1), u(2), . . . , u(N)], and an initial state x(0) to produce predicted outputs in terms of θ. That is, the prediction error function generator 424 predicts:

[ŷ(1|0, θ), ŷ(2|0, θ) . . . ŷ(k|0, θ) . . . , ŷ(N|0, θ)],

where ŷ(k|0, θ) denotes the predicted output at time step k given the training data from time 0 and the model [symbol] (θ). The prediction error function generator 424 then calculates a prediction error at each time step k is given by ε(k, θ):=y(k)−ŷ(k|0, θ). The prediction error function generator 424 then squares the two-norm of each prediction error ε(k, θ) and sums the results to determine the prediction performance function, which can be written as:

V_{N}(θ, Z^{N})=Σₖ₌₁^{N}∥y(k)−ŷ(k|0, θ)∥₂² (Eq. I).

In an alternative embodiment, the prediction error function generator 424 applies a one-step-ahead prediction error method to generate the prediction performance function V_{N}(θ, Z^{N}). In the one-step-ahead prediction error method, the prediction error function generator 424 uses past input-output data and the model [symbol] (θ) the model to predict the output one step ahead in terms of θ. That is, in the one-step ahead prediction error method, the prediction error function generator 424 generates one-step ahead predictions ŷ(k|k−1, θ), which denotes the predicted output at time step k given the past input-output sequence Z^{k-1} and using parameters θ. The one-step ahead prediction ŷ(k|k−1, θ) is then compared to the measured output y(k) by the prediction error function generator 424 to determine the prediction error at k, defined as ε(k, θ):=y(k)−ŷ(k|k−1, θ). The prediction error function generator 424 then squares the two-norm of the prediction errors for each k and sums the results, generating a prediction performance function that can be expressed in a condensed form as:

$${V}_{N} ( θ , {Z}^{N} ) = \frac{1}{N} {\sum }_{k = 1}^{N} {‖ y ( k ) - \hat{y} ( k \vert k - 1 , θ ) ‖}_{2}^{2} . \qquad ( Eq . J )$$

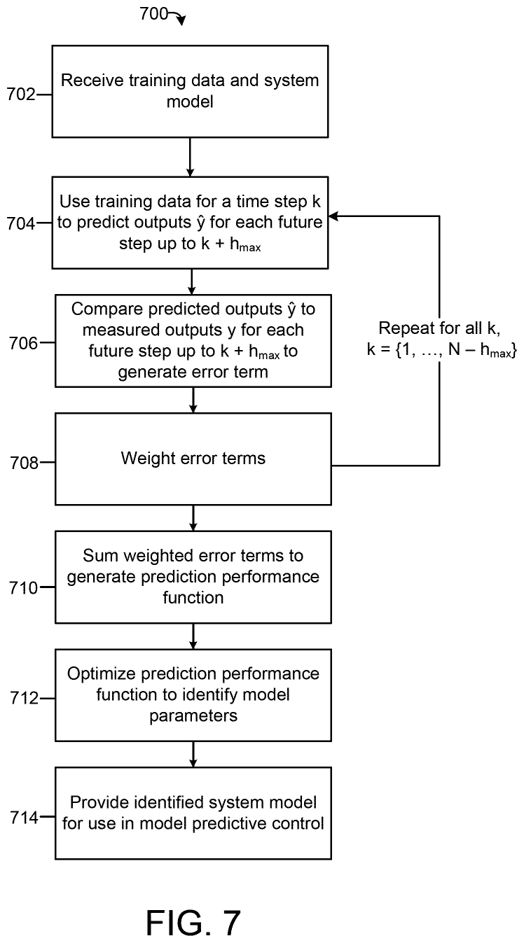

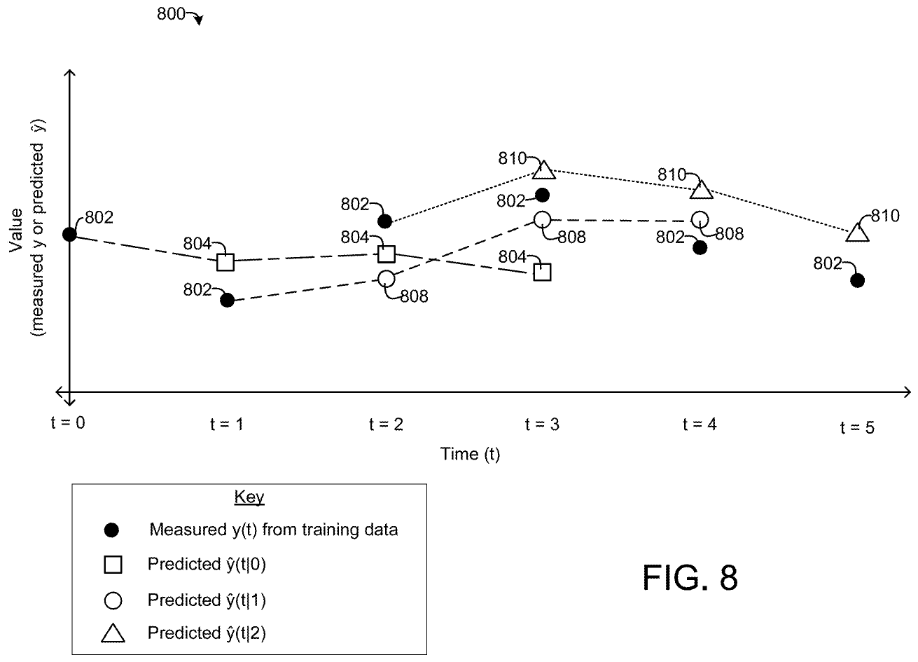

In other alternative embodiments, the prediction error function generator 424 uses a multi-step ahead prediction error approach to generate the prediction performance function. The multi-step ahead prediction error approach is described in detail below with reference to the gain parameter identifier 420 and FIGS. 7-8.

The prediction error function generator 424 then provides the performance function V_{N}(θ, Z^{N}) (i.e., from Eq. I or Eq. J in various embodiments) to the optimizer 426.

The optimizer 426 receives the prediction error function generated by the prediction error function generator 424 and optimizes the prediction error function in θ to determine \hat{θ}_{N}. More specifically, the optimizer 426 finds the minimum value of the prediction error function V_{N}(θ, Z^{N}) as θ is varied throughout the allowable values of θ ∈ [symbol] . That is, the optimizer 426 determines \hat{θ}_{N} based on:

$${\hat{θ}}_{N} = {\hat{θ}}_{N} ( {Z}^{N} ) = arg {min}_{θ ∈ {D}_{ℳ}} {V}_{N} ( θ , {Z}^{N} ) .$$

The optimizer 426 then uses \hat{θ}_{N} to calculate the matrices A, B, C, and D. The system parameter identifier 418 then provides the identified matrices A, B, C, D to the gain parameter identifier 420.

The gain parameter identifier 420 receives the model with the matrices A, B, C, D (i.e., the model parameters) from system parameter identifier 418, as well as the training data Z^{N} from the training data database 410, and uses that information to identify the gain parameters. The gain parameter identifier 420 includes an estimator creator 428, a prediction error function generator 430, and an optimizer 432.

The estimator creator 428 adds a disturbance model and introduces a Kalman estimator gain to account for thermal dynamics of the system, for example for the influence of \dot{Q}ₒₜₕₑᵣ on the system. The estimator creator 428 generates an augmented model with disturbance state d, given by:

$$[ \begin{matrix}\dot{x} ( t ) \\ \dot{d} ( t )\end{matrix} ] = [ \begin{matrix}{A}_{c} & {B}_{d} \\ 0 & 0\end{matrix} ] [ \begin{matrix}x ( t ) \\ d ( t )\end{matrix} ] + [ \begin{matrix}{B}_{c} \\ 0\end{matrix} ] u ( t ) ;$$

$$y ( t ) = [ {C}_{c} {C}_{d} ] [ \begin{matrix}x ( t ) \\ d ( t )\end{matrix} ] + {D}_{c} u ( t )$$

where the parameters A_{c}, B_{c}, C_{c}, and D_{c} are the matrices A, B, C, D received from the system parameter identifier 418 and the disturbance model is selected with

$${B}_{d} = \frac{1}{{C}_{ia}} and {C}_{d} = 0.$$

The estimator creator 428 then converts the model to a discrete time model, for example using 5-minute sampling periods, resulting in the matrices A_{dis}, B_{dis}, C_{dis}, D_{dis} and the disturbance model discrete time matrix B_{d}_{_{dis}}. The estimator creator 428 then adds a parameterized estimator gain, resulting in the following model:

$$\begin{matrix}[ \begin{matrix}\hat{x} ( t + 1 \vert t ) \\ \hat{d} ( t + 1 \vert t )\end{matrix} ] = [ \begin{matrix}{A}_{dis} & {B}_{{d}_{dis}} \\ 0 & I\end{matrix} ] [ \begin{matrix}\hat{x} ( t \vert t - 1 ) \\ \hat{d} ( t \vert t - 1 )\end{matrix} ] + [ \begin{matrix}{B}_{dis} \\ 0\end{matrix} ] u ( t ) + \underbrace{[ \begin{matrix}{K}_{x} ( φ ) \\ {K}_{d} ( φ )\end{matrix} ]}_{= \text{:} K ( φ )} ( y ( t ) - \hat{y} ( t \vert t - 1 ) ) ; & ( Eq . K ) \\ \hat{y} ( t \vert t - 1 ) = [ {C}_{dis} 0 ] [ \begin{matrix}\hat{x} ( t \vert t - 1 ) \\ \hat{d} ( t \vert t - 1 )\end{matrix} ] + {D}_{dis} u ( t ) . & ( Eq . L )\end{matrix}$$

The matrix K(ϕ) is the estimator gain parameterized with the parameter vector ϕ where:

$${K}_{x} ( φ ) = [ \begin{matrix}{φ}_{1} & {φ}_{2} \\ {φ}_{3} & {φ}_{4} \\ {φ}_{5} & {φ}_{6}\end{matrix} ] ;$$

$${K}_{d} ( φ ) = [ {φ}_{7} {φ}_{8} ] .$$

In this notation, \hat{x}(t+1|t) is an estimate of the state at time t+1 obtained using the Kalman filter and made utilizing information at sampling time t. For example, with a sampling time of five minutes, \hat{x}(t+1|t) is an estimate of the state five minutes after the collection of the data that the estimate is based on. The goal of the gain parameter identifier is to identify parameters \hat{ϕ}_{N} (i.e., a vector of for each of ϕ₁ . . . ϕ₈) that make the model best match the physical system.

The estimator creator 428 then provides the discrete time model with estimator gain (i.e., Eqs. K-L) to the prediction error function generator 430. The prediction error function generator receives the model from the estimator creator 428 as well as the training data Z^{N} from the training data database 410, and uses the model (with the estimator gain) and the training data Z^{N} to generate a prediction performance function.

The prediction error function generator 430 follows a multi-step ahead prediction error method to generate a predication performance function V_{N} (ϕ, Z^{N}). The multi-step ahead prediction error method is illustrated in FIGS. 7-8 and described in detail with reference thereto. As an overview, in the multi-step-ahead prediction error method, the prediction error function generator 430 uses past input-output data and the model [symbol] (θ) the model to predict the output multiple step ahead in terms of ϕ. That is, in the multi-step ahead prediction error method, the prediction error function generator 430 generates multi-step ahead predictions ŷ(k+h|k−1, ϕ), which denotes the predicted output at time step k+h given the past input-output sequence Z^{k-1} and using parameters ϕ. The index h corresponds the number of steps ahead the prediction is made, and for each time step k predictions are made for h=0, . . . , hₘₐₓ (i.e., when h=2, the prediction is three steps ahead because h is indexed from zero).

Each multiple multi-step ahead prediction ŷ(k+h|k−1, θ) is then compared to the corresponding measured output y(k) by the prediction error function generator 430 to determine the prediction error at k, defined as ε(k, θ):=y(k)−ŷ(k+h|k−1, ϕ). The prediction error function generator 430 then squares the two-norm of the prediction errors for each k and sums the results, in some embodiments using an weighting function w(h). The prediction error function generator 430 thereby generates a prediction performance function that can be expressed in a condensed form as:

$${V}_{N} ( φ , {Z}^{N} ) = {\sum }_{k = 1}^{N - {h}_{max} + 1} {\sum }_{h = 0}^{{h}_{max}} w ( h ) {‖ y ( k + h ) - \hat{y} ( k + h \vert k - 1 , φ ) ‖}_{2}^{2} . \qquad ( Eq . M )$$

The multi-step ahead prediction error method is described in more detail below with reference to FIGS. 7-8. In alternative embodiments, the prediction error function generator 430 follows the simulation approach or the one-step ahead prediction error approach discussed above with reference to the prediction error function generator 424.

The prediction error function generator 430 then provides the prediction performance function (i.e., Eq. M) to the optimizer 432. The optimizer 432 receives the prediction error function V_{N}(ϕ, Z^{N}) generated by the prediction error function generator 430 and optimizes the prediction error function in ϕ to determine \hat{ϕ}_{N}. More specifically, the optimizer 426 finds the minimum value of the prediction error function V_{N}(ϕ, Z^{N}) as ϕ is varied throughout the allowable values of ϕ. In some cases, all real values of ϕ are allowable. That is, the optimizer 426 determines \hat{ϕ}_{N} based on:

\hat{ϕ}_{N}=\hat{ϕ}_{N}(Z^{N})=arg min_{ϕ}V_{N}(ϕ, Z^{N}).

The optimizer 432 then uses \hat{ϕ}_{N} to calculate the matrices Kₓ(ϕ) and K_{d}(ϕ), resulting in a fully identified model. The gain parameter identifier 420 provides the identified model to the model predictive controller 414.

In some embodiments, the prediction error function generator 430 reconfigures the multi-step ahead prediction problem by defining augmented vectors that allow the multi-step ahead prediction performance function (Eq. M) to be recast in an identical structure to the single-step ahead prediction performance function (Eq. J). Existing software toolboxes and programs (e.g., Matlab system identification toolbox) configured to handle the single-step ahead prediction error approach can then be used to carry out the multi-step ahead prediction error approach. To reconfigure the problem for that purpose, the prediction error function generator 430 considers, the system model of the form:

x(k+1)=Ax(k)+Bu(k);

y(k)=Cx(k)+Du(k).

where the one-step prediction of \hat{x}(k+1|k) using a steady-state Kalman gain is:

\hat{x}(k+1|k)=A\hat{x}(k|k−1)+Bu(k)+K(y(k)−C\hat{x}(k|k−1)−Du(k));

ŷ(k|k−1)=C\hat{x}(k|k−1)+Du(k).

In the multi-step prediction Kalman gain system identification problem, the complete pattern of the algebraic manipulations is shown by the 4-step prediction. The prediction error function generator 430 considers a case with four input data points and four output data-points starting from time h=0 to time h=3, so that hₘₐₓ=3. The one-step prediction (with the prediction error function generator 430 given x0) is given by the equation:

\hat{x}(1|0)=Ax0+Bu(0)+K(y(0)−Cx0−Du(0));

ŷ(0|0)=Cx0+Du(0).

The prediction of the second step is

\hat{x}(2|0)=A\hat{x}(1|0)+Bu(1)=A(Ax0+Bu(0)+K(y(0)−Cx0−Du(0)))+Bu(1);

ŷ(1|0)=C\hat{x}(1|0)+Du(1)=C(Ax0+Bu(0)+K(y(0)−Cx0−Du(0)))+Du(1).

The prediction of the third step is

$$\hat{x} ( 3 \vert 0 ) = A \hat{x} ( 2 \vert 0 ) + Bu ( 2 ) = A ( A ( Ax 0 + Bu ( 0 ) + K ( y ( 0 ) - Cx 0 - Du ( 0 ) ) ) + Bu ( 1 ) ) + Bu ( 2 ) ;$$

$$\hat{y} ( 2 \vert 0 ) = C \hat{x} ( 2 \vert 0 ) + Du ( 2 ) = C ( A ( Ax 0 + Bu ( 0 ) + K ( y ( 0 ) - Cx 0 - Du ( 0 ) ) ) + Bu ( 1 ) ) + Du ( 2 ) .$$

The forth step prediction is

$$\hat{x} ( 4 \vert 0 ) = A \hat{x} ( 3 \vert 0 ) + Bu ( 3 ) = A ( A ( A ( Ax 0 + Bu ( 0 ) + K ( y ( 0 ) - Cx 0 - Du ( 0 ) ) ) + Bu ( 1 ) ) + Bu ( 2 ) ) + Bu ( 3 ) ;$$

$$\hat{y} ( 3 \vert 0 ) = C \hat{x} ( 3 \vert 0 ) + Du ( 3 ) = C ( A ( A ( Ax 0 + Bu ( 0 ) + K ( y ( 0 ) - Cx 0 - Du ( 0 ) ) ) + Bu ( 1 ) ) + Bu ( 2 ) ) + Du ( 3 ) .$$

With these 4-step predictions, the pattern needed to cast the multi-step prediction problem as a 1-step prediction is revealed. By aggregating the matrices multiplying x0, y(0),u(0), u(1),u(2),and u(3), the pattern revealed is:

\hat{x}(1|0)=Ax0+Bu(0)+K(y(0)−Cx0−Du(0));

\hat{x}(2|0)=(A²−AKC)x0+(AB−AKD)u(0)+Bu(1)+AKy(0);

\hat{x}(3|0)=(A³−A²KC)x0+(A²B−A²KD)u(0)+ABu(1)+Bu(2)+A²Ky(0);

\hat{x}(4|0)=(A⁴−A³KC)x0+(A³B−A³KD)u(0)+A²Bu(1) ABu(2)+Bu(3)+A³Ky(0);

ŷ(0)=Cx0+Du(0);

ŷ(1|0)=(CA−CKC)x0+(CB−CKD)u(0)+Du(1)+CKy(0);

ŷ(2|0)=(CA²−CAKC)x0+(CAB−CAKD)u(0)+CBu(1)+Du(2)+CAKy(0);

ŷ(3|0)=(CA³−CA²KC)x0+(CA²B−CA²KD)u(0)+CABu(1)+CBu(2)+Du(3)+CA²Ky(0).

Based on that pattern, the prediction error function generator 430 defines the following vectors:

$$\tilde{u} ( 0 ) = [ \begin{matrix}u ( 0 ) \\ u ( 1 ) \\ u ( 2 ) \\ u ( 3 ) \\ y ( 0 )\end{matrix} ] , \tilde{\hat{y}} ( 0 ) = [ \begin{matrix}\hat{y} ( 0 ) \\ \hat{y} ( 1 \vert 0 ) \\ \hat{y} ( 2 \vert 0 ) \\ \hat{y} ( 3 \vert 0 )\end{matrix} ] , \tilde{y} ( 0 ) = [ \begin{matrix}y ( 0 ) \\ y ( 1 ) \\ y ( 2 ) \\ y ( 3 )\end{matrix} ] , \hat{x} ( 1 \vert 0 ) and x 0 remain unchanged .$$

The new system that has the 4-step prediction casted into a one-step prediction which can be analyzed by the prediction error function generator 430 using an existing system identification software product as:

$$\hat{x} ( 1 \vert 0 ) = Ax 0 + [ B 0 \; 0 \; 0 \; 0 ] \tilde{u} ( 0 ) + [ K 0 \; 0 \; 0 ] ( \tilde{y} ( 0 ) - \tilde{\hat{y}} ( 0 ) ; \\ \tilde{\hat{y}} ( 0 ) = [ \begin{matrix}C \\ ( CA - CKC ) \\ ( {CA}^{2} - CAKC ) \\ ( {CA}^{3} - {CA}^{2} KC )\end{matrix} ] x 0 + [ \begin{matrix}D & 0 & 0 & 0 & 0 \\ ( CB - CKD ) & D & 0 & 0 & CK \\ ( CAB - CAKD ) & CB & D & 0 & CAK \\ ( {CA}^{2} B - {CA}^{2} KD ) & CAB & CB & D & {CA}^{2} K\end{matrix} ] \tilde{\hat{y}} ( 0 ) .$$

In order to have the general formulation at time k for predicting hₘₐₓ step ahead in time, this four-step example can be extrapolated to define the general augmented input and output vectors as:

$$\tilde{\hat{y}} ( k ) = [ \begin{matrix}C \\ ( CA - CKC ) \\ ( {CA}^{2} - CAKC ) \\ ⋮ \\ ( {CA}^{{h}_{max}} - {CA}^{{h}_{max} - 1} KC )\end{matrix} ] \hat{x} ( k \vert k - 1 ) + [ \begin{matrix}D & 0 & 0 & 0 & 0 & 0 & 0 \\ ( CB - CKD ) & D & 0 & 0 & 0 & 0 & CK \\ ( CAB - CAKD ) & CB & D & 0 & 0 & 0 & CAK \\ ( {CA}^{2} B - {CA}^{2} KD ) & CAB & ⋱ & ⋱ & 0 & 0 & {CA}^{2} K \\ ⋮ & ⋮ & ⋱ & CB & D & 0 & ⋮ \\ ( {CA}^{{h}_{max} - 1} B - {CA}^{{h}_{max} - 1} KD ) & {CA}^{{h}_{max} - 2} B & ⋯ & CAB & CB & D & {CA}^{{h}_{max} - 1} K\end{matrix} ] \tilde{u} ( k ) ;$$

$$\tilde{u} ( k ) = [ \begin{matrix}u ( k ) \\ u ( k + 1 ) \\ ⋮ \\ u ( k + {h}_{max} ) \\ y ( k )\end{matrix} ] , \tilde{\hat{y}} ( k ) = [ \begin{matrix}\hat{y} ( k \vert k + 1 ) \\ \hat{y} ( k + 1 \vert k - 1 ) \\ ⋮ \\ \hat{y} ( k + {h}_{max} \vert k - 1 )\end{matrix} ] , \tilde{y} ( k ) = [ \begin{matrix}y ( k ) \\ y ( k + 1 ) \\ ⋮ \\ y ( k + {h}_{max} )\end{matrix} ]$$

With these definition, the general formulation at time k for predicting hₘₐₓ steps ahead in time is:

\hat{x}(k+1|k)=A\hat{x}(k|k−1)+[B 0 . . . 0]ũ(k)+[K 0 . . . 0](\tilde{y}(k)−\tilde{ŷ}(k).

As described above, in the multi-step ahead prediction error method the prediction error function generator 430 generates a function of the form:

$${V}_{N} ( φ , {Z}^{N} ) = {\sum }_{k = 1}^{N - {h}_{max} + 1} {\sum }_{h = 0}^{{h}_{max}} w ( h ) {‖ y ( k + h ) - \hat{y} ( k + h \vert k - 1 , φ ) ‖}_{2}^{2} . \qquad ( Eq . M )$$

If w(h)≡1 for all h, and using the augmented input and output vectors defined above, the multi-step ahead prediction performance function can be reconfigured into the following one-step ahead prediction performance function by the prediction error function generator 430:

$${V}_{N} ( φ , {Z}^{N} ) = {V}_{N} ( θ , {Z}^{N} ) = {\sum }_{k = 1}^{N - {h}_{max} + 1} {‖ \tilde{y} ( k ) - {y}^{\tilde{\hat{}}} ( k , θ ) ‖}_{2}^{2}$$

The prediction error function generator 430 then uses this reconfigured format of the prediction performance function with existing software toolboxes suited for the one-step ahead prediction error approach. The prediction error function generator 430 may include machine-readable media storing computer code executable to apply such software.

### System Identification Methods

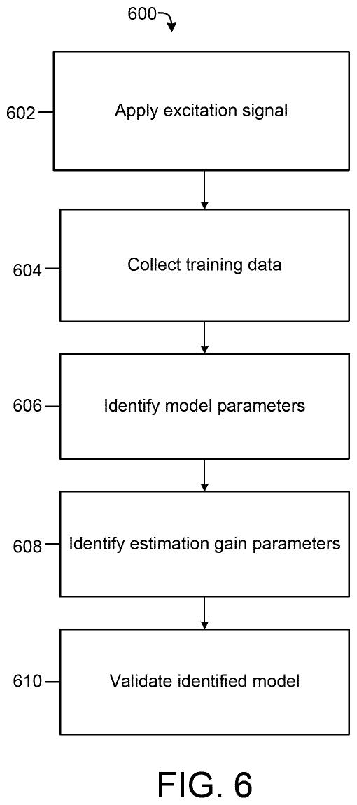

Referring now to FIG. 6, a flowchart of a process 600 for system identification is shown, according to an exemplary embodiment. The process 600 can be carried out by the controller 212 of FIGS. 2 and 4.

At step 602, the controller 212 applies an excitation signal to the HVAC equipment 210. For example, the training data generator 408 may vary the \dot{Q}_{HVAC} values supplied to the equipment controller 416, causing an excitation signal to be generated in the temperature setpoint Tₛₚ inputs provided to the HVAC equipment 210. In general, the excitation signal is designed to test the system in a way to provide robust data for use in system identification.

At step 604, training data is collected and stored by the controller 212. Training data includes measureable temperature readings, i.e., Tₒₐ and Tᵢₐ, controller-determined values \dot{Q}_{HVAC} and Tₛₚ for each of a plurality of time steps k, k=0, . . . , N. The training data therefore includes inputs u(k) and the outputs y(k) for the time period. The training data is received from temperature sensors 214, 216, training data generator 408, and/or equipment controller 416 and stored in training data database 410.

At step 606, the controller 212 identifies the model parameters for the system. That is, as discussed in detail above, the controller 212 determines the matrices A(θ), B(θ), C(θ), and D(θ) that minimize a prediction performance function V_{N}(Z^{N}, θ) for the model:

\dot{x}(t)=A_{c}(θ)x(t)+B_{c}(θ)u(t); (Eq. G)

y(t)=C_{c}(θ)x(t)+D_{c}(θ)u(t); (Eq. H).

In identifying the model parameters, a simulation approach or a one-step-ahead prediction error approach is followed in some embodiments. These approaches are described in detail above with reference to the prediction error function generator 424 of FIG. 5. In other embodiments, the model parameters are determined at step 606 using a multi-step ahead prediction error method, described in detail with reference to FIGS. 7-8.

At step 608, the controller 212 identifies the gain estimator parameters. That is, the controller 212 determines the matrices Kₓ and K_{d} of Eq. K above. In preferred embodiments, the controller 212 uses the multi-step ahead prediction error method to find the matrices Kₓ and K_{d}. The multi-step ahead prediction error method is described in detail below with reference to FIGS. 7-8. In alternative embodiments, a simulation approach or a one-step-ahead prediction error approach is followed to find the matrices Kₓ and K_{d}.

At step 610, the identified model is validated by the controller 212. The controller 212 uses the identified model to generate control signal inputs Tₛₚ for the HVAC equipment 210 using model predictive control. The controller then monitors the temperature measurements Toa and Tᵢₐ from temperature sensors 214, 216, the input Tₛₚ, and the value \dot{Q}_{HVAC} to determine how well the model matches system behavior in normal operation. For example, the training data database 410 may collect and store an addition set of training data that can be used by the model identifier 412 to validate the model. If some discrepancy is determined, the identified model may be updated. The identified model can thereby by dynamically adjusted to adjust for changes in the physical system.

Referring now to FIGS. 7-8 the multi-step ahead prediction error approach for use in system identification is illustrated, according to an exemplary embodiment. In FIG. 7, a flowchart of a process 700 for identifying system parameters using the multi-step ahead prediction error approach is shown, according to an exemplary embodiment. FIG. 8 shows an example visualization useful in explaining process 700. Process 700 can be carried out by the system parameter identifier 418 and/or the gain parameter identifier 420 of FIG. 5. In the embodiment described herein, the process 700 is implemented with the gain parameter identifier 420.

Process 700 begins at step 702, where the gain parameter identifier 420 receives training data Z^{N}=[y(1), u(1), y(2), u(2), . . . , y(N), u(N)] from the training data database 410. The training data includes measured outputs y(k) (i.e., Tᵢₐ(k) and \dot{Q}_{HVAC}(k)) and inputs u(k) (i.e., Tₒₐ(k) and Tₛₚ(k)) for each time step k, k=1, . . . , N. N is the number of samples in the training data. The gain parameter identifier 420 also receives the system model from the system parameter identifier 418.

At step 704, the prediction error function generator 430 uses the training data for a time step k to predict outputs ŷ for each subsequent time step up to k+hₘₐₓ. The value hₘₐₓ corresponds to the number of steps ahead the predictions are made, referred to herein as the prediction horizon. Because hₘₐₓ is indexed from zero in Eq. M above, the prediction horizon is one more than the value of hₘₐₓ. For example, in the case shown in FIG. 8 and described below, predictions are made three steps ahead, corresponding to hₘₐₓ=2 in the notation of Eq. D and a prediction horizon of three. The prediction horizon may be any integer greater than one, for example four or eight. The prediction horizon can be tuned experimentally, to determine an ideal prediction horizon. For example, too long of a prediction horizon may lead to poor prediction while too short of a prediction horizon may suffer the same limitations as the one-step ahead prediction error method mentioned above. In some cases, a prediction horizon of eight is preferred.

More specifically, at each step 704 the predicted outputs [ŷ(k|k−1), ŷ(k+1|k−1), . . . ŷ(k+hₘₐₓ|k−1)] are predicted based on the past training data (i.e., through step k−1), denoted as Z^{k-1}, along with future inputs [u(k), u(k+1) . . . u(k+hₘₐₓ)]. These predictions are made using the model [symbol] (ϕ), such that predicted outputs ŷ depend on ϕ.

To illustrate the predictions of step 704, FIG. 8 shows a simplified visualization in which y(k) and ŷ(k) are depicted as scalar values for the sake of simplified explanation. In FIG. 8, the graph 800 plots the values of y and ŷ over time t for five time steps past a starting time t=0. The solid circles 802 represent measured outputs y(t) from the training data. The unfilled boxes 804 represent predicted outputs ŷ(t|0), that is, the outputs predicted for each time step based on the input/output data available at time t=0 (e.g., y(0)). The dashed lines represent the propagation of the predictions; for example, graph 800 includes three unfilled boxes 804 connected by a dashed line to the solid circle 802 corresponding to y(0). This shows that the predictions ŷ(t|0), 1≤t≤3, represented by the unfilled boxes 804 were based on the measured value of y(0).

At step 706, the prediction error function generator 430 compares the predicted outputs ŷ to the measured outputs y for each future step up to k+hₘₐₓ (i.e., for all predicted outputs ŷ generated at step 704). More specifically, an error term for each step may be defined as y(k+h)−ŷ(k+h|k−1, ϕ). Because y and ŷ are vectors, the two-norm of this error term may be taken and squared to facilitate comparison between prediction errors as scalars, such that the error term becomes ∥y(k+h)−ŷ(k+h|k−1, ϕ)∥₂². This term appears in Eq. M above.

As shown in FIG. 8, step 706 can be understood as measuring the distance between, for example, each unfilled box 804 and the corresponding solid circle 802 (i.e., the unfilled box 804 and the solid circle 802 at the same time t). Thus, in the example of FIG. 8, step 706 includes calculating three error terms.

At step 708, the error terms are weighted based on a weighting function w(h). The weighting function w(h) allows the prediction errors to be given more or less weight depending on how many steps ahead the prediction is. The weighting function w(h) is preferably a monotonically decreasing function of h, so that farther-out-in-time predictions have less influence on the prediction error. In some embodiments, the weighting function w(h)=1. Step 708 thereby corresponds the w(h) term in Eq. M above.

The process 700 then returns to step 704 to repeat steps 704-706 for each value of k, k=1, N−hₘₐₓ. As illustrated in FIG. 8, repeating step 704 corresponds to generating the predictions represented by the unfilled circles 808 and the unfilled triangles 810. The unfilled circles 808 chart the predictions based on the output data available at time t=1, i.e., ŷ(t|1), for t=2, 3, 4. The unfilled triangles chart the predictions based on the output data available at time t=2, i.e., ŷ(t|2), for t=3, 4, 5. Process 700 therefore involves making multiple predictions for most time steps: for example, FIG. 8 shows three separate predictions for time t=3.

At step 706, the prediction error function generator 430 again compares the predicted outputs ŷ for the new value of k to the measured outputs y for each future step up to k+hₘₐₓ to define the error term ∥y(k+h)−ŷ(k+h|k−1, θ)∥₂² as included in Eq. M. At step 708, the terms are again weighted by the weighting function w(h). The weighting function w(h) may be the same for each k.

In the notation of Eq. M, each iteration of steps 704-708 thus corresponds to steps necessary to generate the values used by the inner (right) summation indexed in h, while repetition of the steps 704-708 corresponds to the iteration through k represented in the outer (left) summation. At step 710, then, these summations are executed. In other words, the system identification circuit 108 sums the weighted error terms generated by steps 704-708 to generate a prediction performance function as:

$${V}_{N} ( φ , {Z}^{N} ) = {\sum }_{k = 1}^{N - {h}_{max} + 1} {\sum }_{h = 0}^{{h}_{max}} w ( h ) {‖ y ( k + h ) - \hat{y} ( k + h \vert k - 1 , φ ) ‖}_{2}^{2} . \qquad ( Eq . M )$$

The prediction performance function is a function of the input data Z^{N} and the parameter variable ϕ. Typically, the input data Z^{N} is given (i.e., received by the model identifier 412 and used in the calculation of error terms as described above). Thus, the prediction performance function is primarily a function of ϕ.

At step 712, the prediction performance function V_{N}(ϕ, Z^{N}) is minimized to find an optimal parameter vector

$${\hat{θ}}_{N} = arg {min}_{θ ∈ {D}_{ℳ}} {V}_{N} ( φ , {Z}^{N} ) .$$

Any minimization procedure may be followed. The result of step 712 is a vector \hat{ϕ}_{N} of identified model parameters that tune the model [symbol] (\hat{ϕ}_{N}) to accurately predict system evolution multiple steps ahead. At step 714, the model identifier 412 provides the identified system model (i.e., [symbol] (\hat{ϕ}_{N})) to the model predictive controller 414 for use in generating control inputs for the HVAC equipment 210.

According to various embodiments, process 700 is run once at set-up to establish the system model, run periodically to update the system model, or run repeatedly/continuously to dynamically update the system model in real time.

### Variable Refrigerant Flow Systems

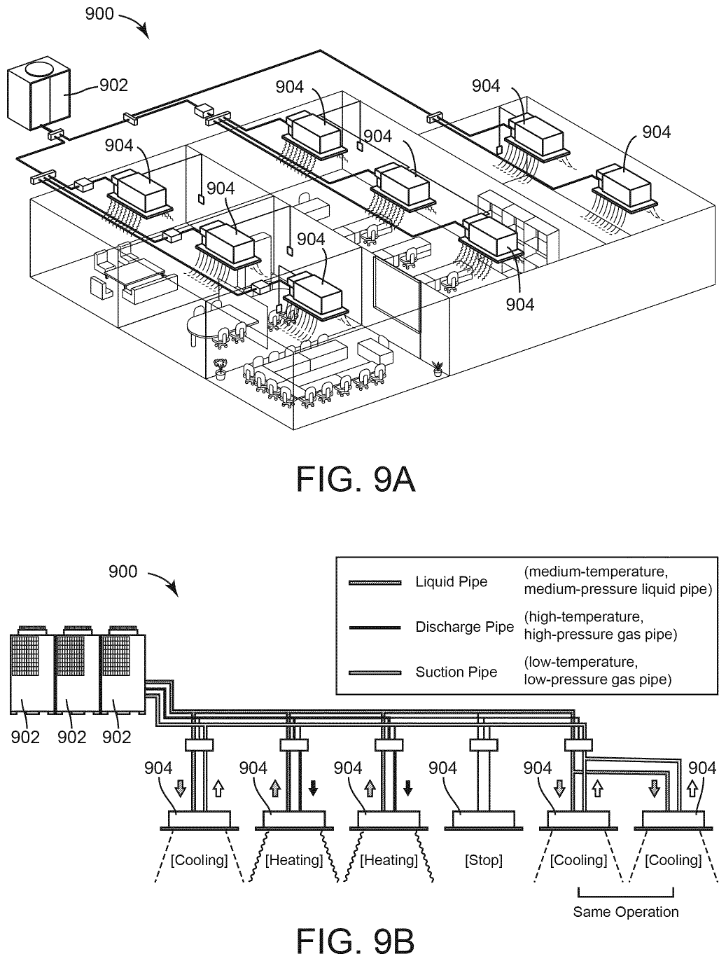

Referring now to FIGS. 9A-9B, a variable refrigerant flow (VRF) system 900 is shown, according to some embodiments. VRF system 900 is shown to include one or more outdoor VRF units 902 and a plurality of indoor VRF units 904. Outdoor VRF units 902 can be located outside a building and can operate to heat or cool a refrigerant. Outdoor VRF units 902 can consume electricity to convert refrigerant between liquid, gas, and/or super-heated gas phases. Indoor VRF units 904 can be distributed throughout various building zones within a building and can receive the heated or cooled refrigerant from outdoor VRF units 902. Each indoor VRF unit 904 can provide temperature control for the particular building zone in which the indoor VRF unit 904 is located. Although the term “indoor” is used to denote that the indoor VRF units 904 are typically located inside of buildings, in some cases one or more indoor VRF units are located “outdoors” (i.e., outside of a building) for example to heat/cool a patio, entryway, walkway, etc.

One advantage of VRF system 900 is that some indoor VRF units 904 can operate in a cooling mode while other indoor VRF units 904 operate in a heating mode. For example, each of outdoor VRF units 902 and indoor VRF units 904 can operate in a heating mode, a cooling mode, or an off mode. Each building zone can be controlled independently and can have different temperature setpoints. In some embodiments, each building has up to three outdoor VRF units 902 located outside the building (e.g., on a rooftop) and up to 128 indoor VRF units 904 distributed throughout the building (e.g., in various building zones). Building zones may include, among other possibilities, apartment units, offices, retail spaces, and common areas. In some cases, various building zones are owned, leased, or otherwise occupied by a variety of tenants, all served by the VRF system 900.

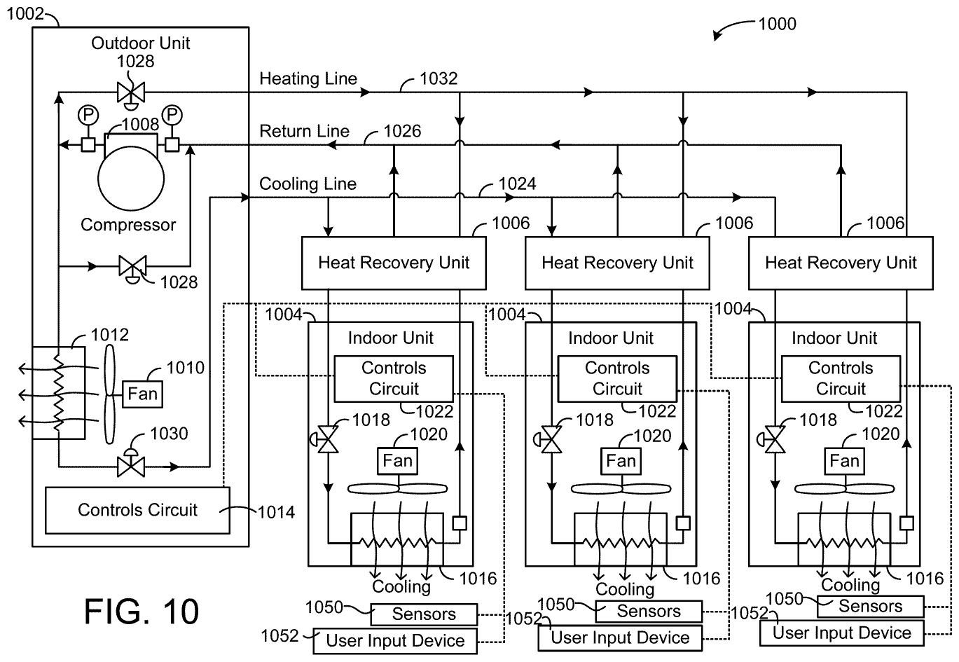

Many different configurations exist for VRF system 900. In some embodiments, VRF system 900 is a two-pipe system in which each outdoor VRF unit 902 connects to a single refrigerant return line and a single refrigerant outlet line. In a two-pipe system, all of outdoor VRF units 902 may operate in the same mode since only one of a heated or chilled refrigerant can be provided via the single refrigerant outlet line. In other embodiments, VRF system 900 is a three-pipe system in which each outdoor VRF unit 902 connects to a refrigerant return line, a hot refrigerant outlet line, and a cold refrigerant outlet line. In a three-pipe system, both heating and cooling can be provided simultaneously via the dual refrigerant outlet lines. An example of a three-pipe VRF system is described in detail with reference to FIG. 10.

Referring now to FIG. 10, a block diagram illustrating a VRF system 1000 is shown, according to an exemplary embodiment. VRF system 1000 is shown to include outdoor VRF unit 1002, several heat recovery units 1006, and several indoor VRF units 1004. Although FIG. 10 shows one outdoor VRF unit 1002, embodiments including multiple outdoor VRF units 1002 are also within the scope of the present disclosure. Outdoor VRF unit 1002 may include a compressor 1008, a fan 1010, or other power-consuming refrigeration components configured convert a refrigerant between liquid, gas, and/or super-heated gas phases. Indoor VRF units 1004 can be distributed throughout various building zones within a building and can receive the heated or cooled refrigerant from outdoor VRF unit 1002. Each indoor VRF unit 1004 can provide temperature control for the particular building zone in which the indoor VRF unit 1004 is located. Heat recovery units 1006 can control the flow of a refrigerant between outdoor VRF unit 1002 and indoor VRF units 1004 (e.g., by opening or closing valves) and can minimize the heating or cooling load to be served by outdoor VRF unit 1002.

Outdoor VRF unit 1002 is shown to include a compressor 1008 and a heat exchanger 1012. Compressor 1008 circulates a refrigerant between heat exchanger 1012 and indoor VRF units 1004. The compressor 1008 operates at a variable frequency as controlled by VRF Controller 1014. At higher frequencies, the compressor 1008 provides the indoor VRF units 1004 with greater heat transfer capacity. Electrical power consumption of compressor 1008 increases proportionally with compressor frequency.

Heat exchanger 1012 can function as a condenser (allowing the refrigerant to reject heat to the outside air) when VRF system 1000 operates in a cooling mode or as an evaporator (allowing the refrigerant to absorb heat from the outside air) when VRF system 1000 operates in a heating mode. Fan 1010 provides airflow through heat exchanger 1012. The speed of fan 1010 can be adjusted (e.g., by VRF Controller 1014) to modulate the rate of heat transfer into or out of the refrigerant in heat exchanger 1012.

Each indoor VRF unit 1004 is shown to include a heat exchanger 1016 and an expansion valve 1018. Each of heat exchangers 1016 can function as a condenser (allowing the refrigerant to reject heat to the air within the room or zone) when the indoor VRF unit 1004 operates in a heating mode or as an evaporator (allowing the refrigerant to absorb heat from the air within the room or zone) when the indoor VRF unit 1004 operates in a cooling mode. Fans 1020 provide airflow through heat exchangers 1016. The speeds of fans 1020 can be adjusted (e.g., by indoor unit controls circuits 1022) to modulate the rate of heat transfer into or out of the refrigerant in heat exchangers 1016.

In FIG. 10, indoor VRF units 1004 are shown operating in the cooling mode. In the cooling mode, the refrigerant is provided to indoor VRF units 1004 via cooling line 1024. The refrigerant is expanded by expansion valves 1018 to a cold, low pressure state and flows through heat exchangers 1016 (functioning as evaporators) to absorb heat from the room or zone within the building. The heated refrigerant then flows back to outdoor VRF unit 1002 via return line 1026 and is compressed by compressor 1008 to a hot, high pressure state. The compressed refrigerant flows through heat exchanger 1012 (functioning as a condenser) and rejects heat to the outside air. The cooled refrigerant can then be provided back to indoor VRF units 1004 via cooling line 1024. In the cooling mode, flow control valves 1028 can be closed and expansion valve 1030 can be completely open.

In the heating mode, the refrigerant is provided to indoor VRF units 1004 in a hot state via heating line 1032. The hot refrigerant flows through heat exchangers 1016 (functioning as condensers) and rejects heat to the air within the room or zone of the building. The refrigerant then flows back to outdoor VRF unit via cooling line 1024 (opposite the flow direction shown in FIG. 10). The refrigerant can be expanded by expansion valve 1030 to a colder, lower pressure state. The expanded refrigerant flows through heat exchanger 1012 (functioning as an evaporator) and absorbs heat from the outside air. The heated refrigerant can be compressed by compressor 1008 and provided back to indoor VRF units 1004 via heating line 1032 in a hot, compressed state. In the heating mode, flow control valves 1028 can be completely open to allow the refrigerant from compressor 1008 to flow into heating line 1032.

As shown in FIG. 10, each indoor VRF unit 1004 includes an indoor unit controls circuit 1022. Indoor unit controls circuit 1022 controls the operation of components of the indoor VRF unit 1004, including the fan 1020 and the expansion valve 1018, in response to a building zone temperature setpoint or other request to provide heating/cooling to the building zone. The indoor unit controls circuit 1022 may also determine a heat transfer capacity required by the indoor VRF unit 1004 and transmit a request to the outdoor VRF unit 1002 requesting that the outdoor VRF unit 1002 operate at a corresponding capacity to provide heated/cooled refrigerant to the indoor VRF unit 1004 to allow the indoor VRF unit 1004 to provide a desired level of heating/cooling to the building zone.

Each indoor unit controls circuit 1022 is shown as communicably coupled to one or more sensors 1050 and a user input device 1052. In some embodiments, the one or more sensors 1050 may include a temperature sensor (e.g., measuring indoor air temperature), a humidity sensor, and/or a sensor measuring some other environmental condition of a building zone served by the indoor VRF unit 1004. In some embodiments, the one or more sensors include an occupancy detector configured to detect the presence of one or more people in the building zone and provide an indication of the occupancy of the building zone to the indoor unit controls circuit 1022.

Each user input device 1052 may be located in the building zone served by a corresponding indoor unit 1004. The user input device 1052 allows a user to input a request to the VRF system 1000 for heating or cooling for the building zone and/or a request for the VRF system 1000 to stop heating/cooling the building zone. According to various embodiments, the user input device 1052 may include a switch, button, set of buttons, thermostat, touchscreen display, etc. The user input device 1052 thereby allows a user to control the VRF system 1000 to receive heating/cooling when desired by the user.

The indoor unit controls circuit 1022 may thereby receive an indication of the occupancy of a building zone (e.g., from an occupancy detector of sensors 1050 and/or an input of a user via user input device 1052). In response, the indoor unit controls circuit 1022 may generate a new request for the outdoor VRF unit 1002 to operate at a requested operating capacity to provide refrigerant to the indoor unit 1004. The indoor unit controls circuit 1022 may also receive an indication that the building zone is unoccupied and, in response, generate a signal instructing the outdoor VRF unit 1002 to stop operating at the requested capacity. The indoor unit controls circuit 1022 may also control various components of the indoor unit 1004, for example by generating a signal to turn the fan 1020 on and off.

The outdoor unit controls circuit 1014 may receive heating/cooling capacity requests from one or more indoor unit controls circuits 1022 and aggregate the requests to determine a total requested operating capacity. Accordingly, the total requested operating capacity may be influenced by the occupancy of each of the various building zones served by various indoor units 1004. In many cases, a when a person or people first enter a building zone and a heating/cooling request for that zone is triggered, the total requested operating capacity may increase significantly, for example reaching a maximum operating capacity. Thus, the total request operating capacity may vary irregularly and unpredictably as a result of the sporadic occupation of various building zones.

The outdoor unit controls circuit 1014 is configured to control the compressor 1008 and various other elements of the outdoor unit 1002 to operate at an operating capacity based at least in part on the total requested operating capacity. At higher operating capacities, the outdoor unit 1002 consumes more power, which increases utility costs. In some embodiments, the VRF controller may be capable of

For an operator, owner, lessee, etc. of a VRF system, it may be desirable to minimize power consumption and utility costs to save money, improve environmental sustainability, reduce wear-and-tear on equipment, etc. In some cases, multiple entities or people benefit from reduced utility costs, for example according to various cost apportionment schemes for VRF systems described in U.S. patent application Ser. No. 15/920,077 filed Mar. 13, 2018, incorporated by reference herein in its entirety. Thus, as described in detail below, the controls circuit 1014 may be configured to manage the operating capacity of the outdoor VRF unit 1002 to reduce utility costs while also providing comfort to building occupants. Accordingly, in some embodiments, the controls circuit 1014 may be operable in concert with systems and methods described in P.C.T. Patent Application No. PCT/US2017/039937 filed Jun. 29, 2017, and/or U.S. patent application Ser. No. 15/635,754 filed Jun. 28, 2017, both of which are incorporated by reference herein in their entireties.

### Peer Analysis for System Identification Parameters

### Overview

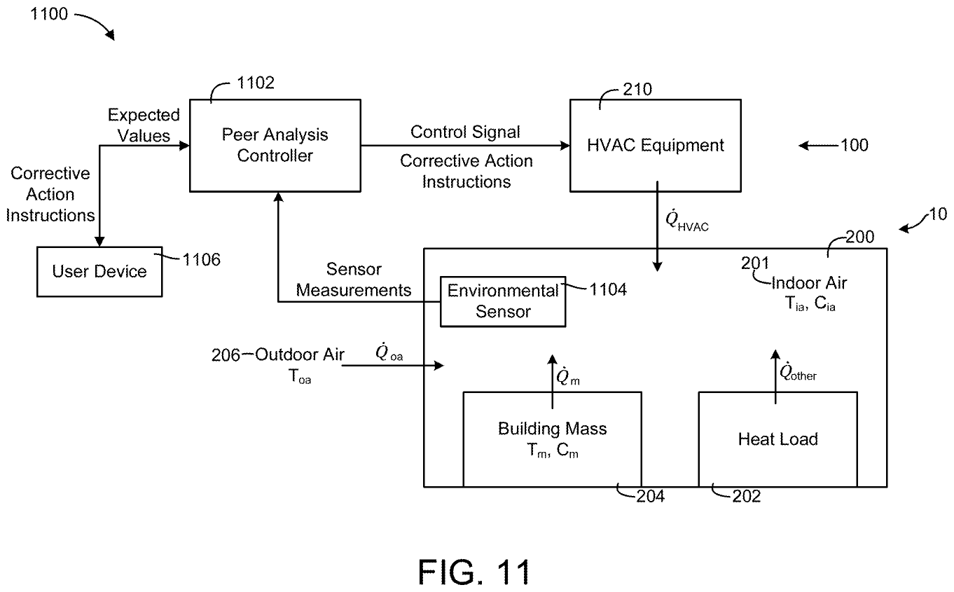

Referring generally to FIGS. 11-15, systems and methods for performing peer analysis to determine accuracy of predictive models are shown, according to some embodiments. Accuracy of a predictive model can be paramount for ensuring that HVAC systems and/or other building systems are operated such that occupant comfort is maintained and operational costs are optimized (e.g., reduced). Predictive models can be generated based on training data describing a system (e.g., zone 200). If the training data is inaccurate and/or not representative of actual system dynamics, predictive models generated based on the training data may inherit inaccuracies present in the training data. Inaccurate predictive models can result in various abnormalities that can affect occupant comfort, incur additional costs, and/or are otherwise not in accordance with preferred outcomes. Specifically, inaccurate predictive models may result in abnormalities in behavior of zones of a building as the zones may be operated based on models that do not reflect actual dynamics of the zones. For example, abnormalities can include operating decisions such as heating during summer months, cooling during winter months, maintaining a single setpoint over an entire day or multiple days, determining setpoints for building equipment known to violate occupant comfort conditions, etc. As such, accuracy of predictive models should be evaluated prior to utilizing the predictive model in order to reduce occurrences of abnormalities. It should be noted that the terms “behavior” and “system dynamics” are used interchangeably throughout the present disclosure.

Inaccuracy of predictive models can result from various sources of inaccuracy associated with the system identification process. For example, predictive model inaccuracy can result from environmental sensors being placed in non-optimal locations. If, for example, a temperature sensor is placed in a closet adjacent to a room, a temperature of the closet may not be affected by operation of HVAC equipment as quickly as the rest of the room. As such, temperature data gathered from the environmental sensor may not be reflective of the room as a whole and may indicate a larger time constant over which temperatures take to adjust than an actual average time constant for the room. As another example, if an HVAC device (e.g., a chiller, a heater, a fan, etc.) undergoes a malfunction during data collection for SI, the collected data may not reflect how the HVAC device operates under standard operating conditions. Inaccuracy of predictive models can worsen as more non-representative data is included in the data set used to perform system identification. However, it may not be clear that non-representative data is included in the data set used to perform system identification. As such, peer analysis can be performed to determine whether a predictive model is accurate and can be used in control-based applications such as model predictive control (MPC).

To determine accuracy of a predictive model, model parameters of the predictive model can undergo a peer analysis. The peer analysis can include comparisons and other analyses between the model parameters and model parameters of other predictive models to determine if the model parameters accurately reflect a system associated with the predictive model and to determine whether zones (or other spaces) of a building are behaving normally or abnormally with respect to other zones. If model parameters for a particular predictive model are abnormal with respect to the other predictive models (e.g., a value of a model parameter is twice as much as the same model parameter for other predictive models), the particular predictive model may contributing to abnormal behavior of an associated zone. In some embodiments, instead of or in addition to comparing model parameters of multiple predictive models, model parameters of a particular predictive model can be compared to expected values of the model parameters. In this case, the expected values may be considered as values that should result in normal zone behavior. In other words, whereas comparisons between model parameters of multiple predictive models may help identify inaccuracy in any of the predictive models, comparisons of model parameters of a particular predictive model to expected values may explicitly determine whether the particular predictive model is accurate and whether an associated zone is behaving normally. In some embodiments, expected values of the model parameters are set by a user. For example, the user may analyze current system dynamics, operation of HVAC equipment, etc. in order to estimate expected values of the model parameters. In some embodiments, expected values are based on model parameters of other predictive models (i.e., comparison models). Expected values of model parameters can also be determined/gathered from other sources such as, for example, databases storing expected values, values estimated by a system/controller, etc.

Comparison models utilized in peer analysis can be selected based on a similarity between systems modeled by the comparison models to the system modeled by the predictive model undergoing peer analysis. System similarity can be determined based on various factors such as a type of system being described (e.g., a conference room, a storage closet, a hallway, an whole building, etc.), what building equipment affects dynamics of the system, a size of a space described by the system, a number of occupants typically in the space, etc. For example, if the predictive model undergoing peer analysis describes dynamics of a conference room, comparison models describing dynamics of other conference rooms can be selected for the peer analysis. As another example, if the predictive model undergoing peer analysis describes dynamics of a space that is typically subject to little solar irradiance and few occupants (e.g., a basement, a storage closet, etc.), the predictive model may not include significant adjustments for heat disturbances. Therefore, comparison models describing other systems affected by little heat disturbance can be selected for the peer analysis. In some embodiments, a single similarity is considered in determining comparison models to utilize in the peer analysis. In some embodiments, multiple similarities are considered in determining comparison models to utilize in the peer analysis.

Based on the comparison models selected to be utilized in the peer analysis, an accuracy of the predictive model in question and the other models can be determined. The model parameters of each predictive model can be compared and analyzed against one another to determine if any predictive model is inaccurate and/or is associated with a zone experiencing abnormal behavior. Example comparisons and analyses can include multivariate outlier analysis, a variance analysis, other outlier analyses, etc. Based on one or more comparisons/analyses performed, a determination can be made regarding whether the predictive models accurately model associated systems (e.g., zones of a building). If the predictive models are determined to be accurate, the predictive model can be used in a control-based application (e.g., MPC) and/or used for some other purpose. If the predictive models are determined to be inaccurate, a corrective action can be initiated. Corrective actions can include actions to ensure inadequacy of the predictive model is addressed. For example, corrective actions can include providing an alert to a user indicating a particular predictive model does not accurately model an associated system, scheduling a maintenance activity to be performed to fix/upgrade components of the system, automatically purchasing new devices, performing a new system identification experiment to gather new training data, etc. In some embodiments, as a result of the corrective action, the predictive model is updated (e.g., retrained) and/or replaced by a new predictive model to better model system dynamics.

### Building Control System

Referring now to FIG. 11, an environmental control system 1100 including HVAC system 100 with building 10 is shown, according to some embodiments. In some embodiments, environmental control system 1100 as shown in FIG. 11 is similar to and/or the same as the HVAC system 100 with building 10 as described above with reference to FIG. 2. As such, FIG. 11 is shown to include various components of FIG. 2 as shown by the same reference numbers.

Building 10 is shown to include an environmental sensor 1104. In some embodiments, environmental sensor 1104 is similar to and/or the same as indoor air temperature sensor 214 and/or outdoor air temperature sensor 216. In some embodiments, environmental sensor 1104 includes multiple environmental sensors. For example, environmental sensor 1104 can include one or more temperature sensors, one or more relative humidity sensors, one or more air quality sensors, and/or some combination thereof. Environmental sensor 1102 can measure environmental conditions affecting building 10, zone 200, and/or an external space. For example, environmental sensor 1102 can measure an indoor air temperature, an outdoor air temperature, an indoor humidity, an outdoor humidity, air quality, etc. In some embodiments, environmental sensor 1104 is configured to measure an appropriate environmental condition that may be required/useful for generating a predictive model of system dynamics for building 10 and/or zone 200. In some embodiments, environmental sensor 1104 measures/estimates other aspects of building 10 and/or zone 200 such as, for example, a thermal resistance between indoor air and outdoor air, a lumped thermal capacitance, an indoor air thermal capacitance, etc. In some embodiments, the other aspects of building 10 and/or zone 200 are provided by a user, estimated by a controller, extracted from a database (e.g., a cloud database), etc.

Environmental sensor 1104 is shown to provide sensor measurements to a peer analysis controller 1102. In some embodiments, peer analysis controller 1102 is similar to and/or the same as controller 212 described above with reference to FIGS. 2 and 4. As such, peer analysis controller 1102 may include some and/or all of the functionality of controller 212. Peer analysis controller 1102 can utilize the sensor measurements to generate a predictive model describing system dynamics of building 10 and/or zone 200. For example, peer analysis controller 1102 may generate a building zone group thermal model defined by the following differential equations:

$${C}_{ia} {\dot{T}}_{ia} = \frac{1}{{R}_{mi}} ( {T}_{m} - {T}_{ia} ) + \frac{1}{{R}_{oi}} ( {T}_{oa} - {T}_{ia} ) + {\dot{Q}}_{HVAC} + {\dot{Q}}_{other}$$

$${C}_{m} {\dot{T}}_{m} = \frac{1}{{R}_{mi}} ( {T}_{ia} - {T}_{m} )$$

where Tᵢₐ is an indoor air temperature, Tₒₐ, is an outdoor air temperature, Tₘ is a lumped thermal mass temperature, Cₘ is a lumped mass thermal capacitance, Cᵢₐ is an indoor air thermal capacitance, Rₘᵢ is an indoor air thermal mass thermal resistance, Rₒᵢ is a thermal resistance between indoor air and outdoor air, \dot{Q}_{HVAC} is a sensible heat provided to/removed from a building space from an HVAC system (e.g., including HVAC equipment 210), and \dot{Q}ₒₜₕₑᵣ is an internal heat load/gains. \dot{Q}ₒₜₕₑᵣ can result from sources of heat disturbances such as, for example, solar radiation, occupancy, and/or electrical equipment.

Inputs to the above building zone group thermal model can include \dot{Q}_{HVAC} which can be measured and controlled, Tₒₐ which can be measured but not controlled, and \dot{Q}ₒₜₕₑᵣ which may not be measured or controlled. States of the building thermal model can include a measured state of Tᵢₐ and an unmeasured state of Tₘ. An output of the thermal model can include Tᵢₐ as a measured output. Obtaining the resistances and capacitances (i.e., Cᵢₐ, Cₘ, Rₘᵢ, Rₒᵢ) can be done through system identification where data for a building zone is collected and used to fit the parameters that provide accurate predictions of the building thermal dynamics. As an example, peer analysis controller 1102 can identify the matrices A, B, C, and D (i.e., the values of θ={θ₁, θ₂, θ₃, θ₄, θ₅, θ₆}) of Eqs. G and H as described above with reference to FIG. 5. The values of θ can then be used to calculate the values of the thermal resistances, capacitances, and other parameters that combine to form the values of θ (e.g., using the equations that define the values of θ as functions of these parameters, as described with reference to FIG. 3). In other words, peer analysis controller 1102 can be configured to find the values of Cᵢₐ, Cₘ, Rₘᵢ, Rₒᵢ, K_{p,j}, and/or K_{i,j}.

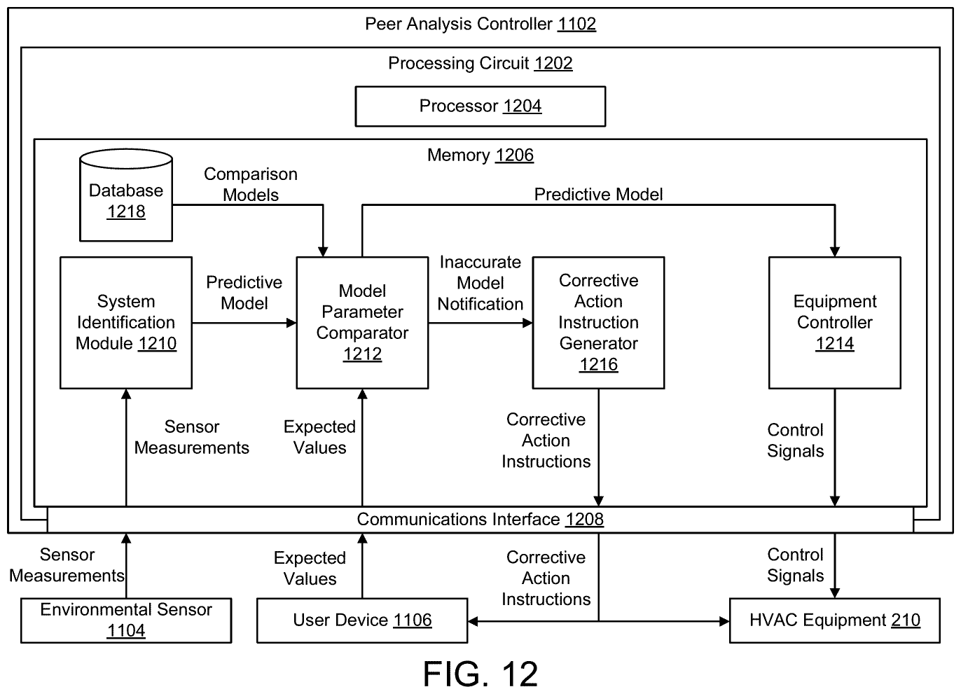

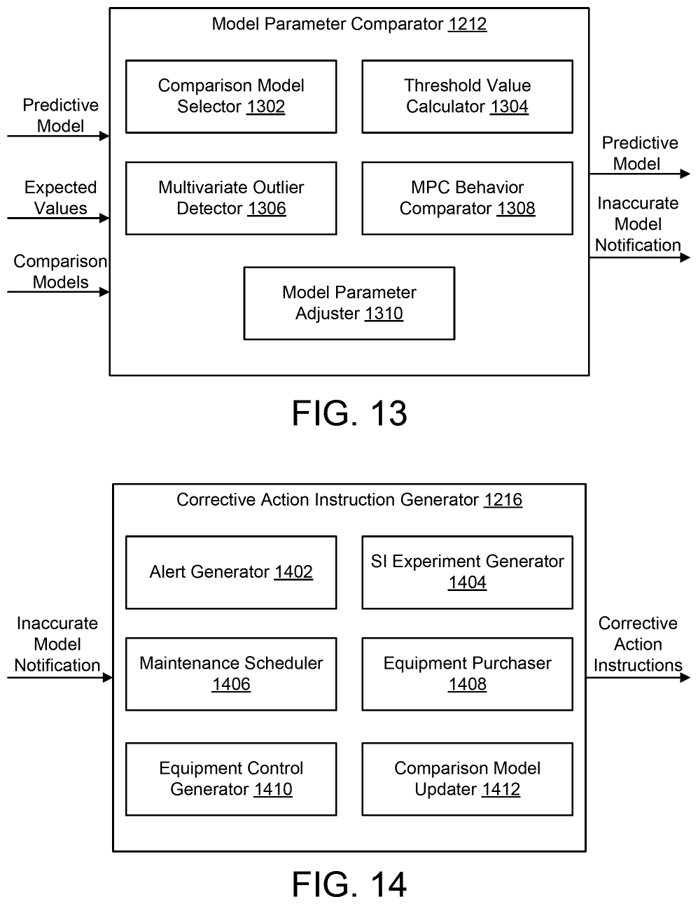

Based on identified model parameters, peer analysis controller 1102 can perform a peer analysis process to determine if the model parameters are reasonable provided the type of system being modeled by the predictive model. Reasonableness of model parameters can be defined by how closely the model parameters match up with expected values and/or with model parameters of other predictive models. Estimating reasonableness of model parameters is described in greater detail below with reference to FIGS. 12-13. As a brief explanation, peer analysis controller 1102 can perform comparisons and/or other analyses between the model parameters of the predictive model and other predictive models. In this case, each predictive model can be compared to determine if any predictive model corresponds with a zone that is behaving abnormally.

In some embodiments, model parameters of the predictive model in question are compared to expected values. Expected values may be received from a user device 1106. User device 1106 can include various devices via which a user can interact with peer analysis controller 1102. For example, user device 1106 may be a desktop computer, a laptop, a smart phone, a smart watch, a thermostat, etc. In some embodiments, expected values are determined based on predictive models for similar systems. For example, if the predictive model generated and analyzed by peer analysis controller 1102 models a classroom, comparison models that model system dynamics of classrooms and/or systems similar to classrooms can be used as a basis for comparison. If the model parameters of the predictive model are similar to model parameters of the comparison models, the model parameters of the predictive model may be determined to be reasonable. If the model parameters are determined to take on reasonable values, the predictive model may be suitable for use in applications such as model predictive control (MPC). However, if some and/or all of the model parameters are unreasonable, the predictive model may be determined to not accurately model the system. Whether the predictive model is accurate or inaccurate can be used to determine if the system (e.g., a zone) is behaving abnormally. Specifically, if the predictive model is determined to be accurate, the system may be behaving normally as model parameters of the predictive model are accurate. However, if the predictive model is determined to be inaccurate, the system may be behaving abnormally (i.e., because operating decisions for the system are based on an inaccurate model).

In some embodiments, regardless of whether the predictive model is compared to other predictive models or expected values, if a single model parameter is unreasonable, the predictive model as a whole is determined to be inaccurate by peer analysis controller 1102. In some embodiments, multiple model parameters are required to be determined to be unreasonable in order for peer analysis controller 1102 to determine the predictive model to be inaccurate and thereby determine an associated system (e.g., a zone) to be behaving abnormally. In some embodiments, peer analysis controller 1102 associates model parameters with a weight such that some model parameters are designated as more critical to an overall accuracy of the predictive model as compared to other model parameters. If weights are associated with model parameters, accuracy of the predictive model can be determined based on what model parameters are determined to be unreasonable. For example, a model parameter associated with a small weight (i.e., a non-critical model parameter) that is determined to be unreasonable may not result in a determination of inaccuracy of the predictive model. However, a different unreasonable model parameter associated with a large weight (i.e., a critical model parameter) may result in the predictive model being determined to be inaccurate. A determination of inaccuracy for the predictive model may require a greater number of model parameters associated with small weights to be unreasonable as compared to model parameters associated with large weights.

In some embodiments, a magnitude of how unreasonable model parameters are is calculated by peer analysis controller 1102. A magnitude of how unreasonable a model parameter is can be determined based on how much a value of the model parameter varies from an expected value, varies from values of model parameters of similar predictive models, and/or an amount the value exceeds a threshold value(s). For example, an expected value of a model parameter can be determined based on a comparable model parameter of a separate predictive model, and threshold values can be set at plus or minus twenty percent from a value of the comparable model parameter. In this example, if the value of the comparable model parameter (i.e., the expected value) is 10, a minimum threshold can be set at 8 and a maximum threshold can be set at 12. If a value of the model parameter in question is between the minimum and maximum thresholds (i.e., between 8 and 12), the model parameter can be considered reasonable. In other words, if the model parameter in question is between the minimum and maximum thresholds, a corresponding system (e.g., a corresponding zone) may be behaving normally. However, if the value of the predictive model is less than the minimum threshold or is greater than the maximum threshold, the magnitude of how unreasonable the model parameter is can be determined based on how much the value of the model parameter is beyond said thresholds. Likewise, a magnitude of abnormal behavior of the corresponding system can be determined respective of the value as compared to the thresholds. Given the above example, a value of the model parameter being 15 may have a larger magnitude (i.e., the model parameter is more unreasonable) as compared to if the value is 13.

In some embodiments, peer analysis controller 1102 utilizes the magnitude of how unreasonable model parameters are along with weights for each model parameter. For example, if a critical model parameter with a high associated weight is calculated to have a small magnitude, the model may still be determined to be accurate. However, if a non-critical model parameter with a low associated weight has a large magnitude, peer analysis controller 1102 may determine that the predictive model is inaccurate. By utilizing weights and magnitudes of model parameters, accuracy of predictive models can be more accurately determined.

It should be appreciated that the calculations and determinations of weight and magnitude as described above are given purely for sake of example. Peer analysis controller 1102 can calculate a weight and/or a magnitude of a model parameter in any appropriate fashion. Further, peer analysis controller 1102 can utilize other methods of determining accuracy of a predictive model based on model parameters. As described in detail below, peer analysis controller 1102 may perform other analyses such as a multivariate outlier analysis. Said other analyses can be used in combination and/or individually to determine accuracy of a predictive model.

If peer analysis controller 1102 determines a predictive model accurately models a system, peer analysis controller 1102 can generate control signals to provide to HVAC equipment 210. However, if peer analysis controller 1102 determines the predictive model does not accurately model the system, peer analysis controller 1102 can determine a corrective action to initiate. As described in greater detail above, corrective actions can include actions such as, for example, providing an alert to a user indicating the predictive model does not accurately model the system, scheduling a maintenance activity to be performed to fix/upgrade components of the system, automatically purchasing new devices, performing a new system identification experiment to gather new training data, etc. Peer analysis controller 1102 can determine one or more corrective actions to initiate in response to determining the predictive model is inaccurate.

In some embodiments, if peer analysis controller 1102 determines a predictive model to be inaccurate, peer analysis controller 1102 determines specific corrective actions to take based on what model parameters are determined to be unreasonable. In other words, peer analysis controller 1102 can determine specific corrective actions to initiate based on what aspects of a system corresponding to the predictive model are behaving abnormally. Certain model parameters can be associated with different aspects of the system and therefore can be associated with different corrective actions. For example, if a model parameter related to a heat disturbance affecting a space is inaccurate, peer analysis controller 1102 may determine that environmental sensors (e.g., environmental sensor 1104) should be replaced to ensure that measured temperature values are accurate. As another example, if a model parameter related to operation of HVAC equipment 210 is inaccurate, peer analysis controller 1102 may determine that some and/or all devices of HVAC equipment 210 should be replaced to ensure HVAC equipment 210 provides appropriate heating/cooling to the space.

In some embodiments, determining a source of inaccuracy in predictive models and/or of unreasonableness of model parameters is difficult and/or impossible. In particular, identification of some model parameters may result from multiple factors (e.g., devices, people, dynamics, etc.) such that identifying a particular source of why the model parameters are unreasonable may be difficult and/or impossible. If determining a source of inaccuracy in predictive models and/or of unreasonableness of model parameters is difficult and/or impossible, peer analysis controller 1102 may determine corrective actions to initiate based on a severity of inaccuracy/unreasonableness, a predetermined list of corrective actions, etc. For example, if the predictive model is extremely inaccurate (i.e., the severity of inaccuracy is high), a more intensive (e.g., expensive) corrective action such as replacing building equipment may be performed. As another example, peer analysis controller 1102 may always initiate a first corrective action of notifying a user regarding inaccuracy/unreasonableness and performs a second corrective action based on user feedback.

Based on what corrective action(s) are determined to be performed, peer analysis controller 1102 can generate corrective action instructions detailing execution of said corrective action(s). For example, if peer analysis controller 1102 determines the corrective actions should include alerting a user that the predictive model is inaccurate and performing a new system identification experiment, peer analysis controller 1102 can generate two sets of instructions and distribute said sets accordingly. Specifically, peer analysis controller 1102 can generate a first set of corrective action instructions regarding the alert and can provide the first set to user device 1106. The first set of corrective action instructions can include various information such as in what form(s) to alert the user (e.g., via text, via email, etc.), a time to alert the user, what user(s) to notify, etc. By providing the first set of corrective action instructions to user device 1106, peer analysis controller 1102 can initiate the corrective action of alerting the user. Further, peer analysis controller 1102 can generate a second set of corrective action instructions regarding the new system identification experiment and can provide the second set to HVAC equipment 210. The second set of corrective action instructions can include information such as what devices of HVAC equipment 210 to operate, when to operate said devices, one or more setpoints for the devices to operate based on, etc. By providing the second set of corrective action instructions to HVAC equipment 210, peer analysis controller 1102 can initiate the corrective action of performing the new system identification experiment. It should be appreciated that user device 1106 and HVAC equipment 210 are shown to receive corrective action instructions from peer analysis controller 1102 in environmental control system 1100 purely for sake of example. Peer analysis controller 1102 can provide corrective action instructions to any appropriate device, system, controller, etc., in order to initiate a corrective action.

By performing a peer analysis to determine accuracy of predictive models, peer analysis controller 1102 can ensure that predictive models used in MPC and/or other control-based applications result in generation of control actions that maintain occupant comfort and reduce costs for an associated system (e.g., building 10). Further, peer analysis controller 1102 can identify inaccurate predictive models and can initiate appropriate corrective actions based on what model parameters are determined to be inaccurate in the predictive models. Peer analysis controller 1102 is described in greater detail below with reference to FIG. 12.

### Controller for Performing Peer Analysis of Predictive Models

Referring now to FIG. 12, peer analysis controller 1102 is shown in greater detail, according to some embodiments. As described in detail above with reference to FIG. 11, peer analysis controller 1102 can generate a predictive model by performing a system identification process and can perform a peer analysis to determine if the predictive model adequately models an associated system based on expected values of model parameters. If the predictive model adequately models the associated system, the predictive model can be used in control-based applications (e.g., MPC) and/or other various applications. If the predictive model does not adequately model the associated system, peer analysis controller 1102 can initiate a corrective action to address inaccuracy of the predictive model. In some embodiments, peer analysis controller 1102 is similar to and/or the same as controller 212 as described with reference to FIGS. 2 and 4. As such, peer analysis controller 1102 can include some and/or all of the functionality of controller 212.

Peer analysis controller 1102 is shown to include a communications interface 1208 and a processing circuit 1202. Communications interface 1208 may include wired or wireless interfaces (e.g., jacks, antennas, transmitters, receivers, transceivers, wire terminals, etc.) for conducting data communications with various systems, devices, or networks. For example, communications interface 1208 may include an Ethernet card and port for sending and receiving data via an Ethernet-based communications network and/or a Wi-Fi transceiver for communicating via a wireless communications network. Communications interface 1208 may be configured to communicate via local area networks or wide area networks (e.g., the Internet, a building WAN, etc.) and may use a variety of communications protocols (e.g., BACnet, IP, LON, etc.).

Communications interface 1208 may be a network interface configured to facilitate electronic data communications between peer analysis controller 1102 and various external systems or devices (e.g., environmental sensor 1104, user device 1106, HVAC equipment 210, etc.). For example, peer analysis controller 1102 may receive environmental data from environmental sensor 1104 indicating one or more environmental conditions (e.g., temperature, humidity, air quality, etc.) via communications interface 1208. In some embodiments, communications interface 1208 is configured to provide control signals to HVAC equipment 210. In some embodiments, peer analysis controller 1102 utilizes communications interface 1208 to distribute corrective action instructions to external devices, controllers, systems, etc.

Still referring to FIG. 12, processing circuit 1202 is shown to include a processor 1204 and memory 1206. Processor 1204 may be a general purpose or specific purpose processor, an application specific integrated circuit (ASIC), one or more field programmable gate arrays (FPGAs), a group of processing components, or other suitable processing components. Processor 1204 may be configured to execute computer code or instructions stored in memory 1206 or received from other computer readable media (e.g., CDROM, network storage, a remote server, etc.).

Memory 1206 may include one or more devices (e.g., memory units, memory devices, storage devices, etc.) for storing data and/or computer code for completing and/or facilitating the various processes described in the present disclosure. Memory 1206 may include random access memory (RAM), read-only memory (ROM), hard drive storage, temporary storage, non-volatile memory, flash memory, optical memory, or any other suitable memory for storing software objects and/or computer instructions. Memory 1206 may include database components, object code components, script components, or any other type of information structure for supporting the various activities and information structures described in the present disclosure. Memory 1206 may be communicably connected to processor 1204 via processing circuit 1202 and may include computer code for executing (e.g., by processor 1204) one or more processes described herein. In some embodiments, one or more components of memory 1206 are part of a singular component. However, each component of memory 1206 is shown independently for ease of explanation.

Memory 1206 is shown to include a system identification module 1210. In some embodiments, SI module 1210 includes some and/or all of the functionality of model identifier 412 as described with reference to FIG. 4. As such, SI module 1210 can include some and/or all of the functionality of system parameter identifier 418 and/or gain parameter identifier 420. SI module 1210 can perform a system identification process to generate a predictive model that models a system. The SI process can utilize sensor measurements provided by environmental sensor 1104 via communications interface 1208. In some embodiments, the SI process performed by SI module 1210 is described in greater detail in U.S. patent application Ser. No. 15/953,324 filed Apr. 13, 2018 and in U.S. patent application Ser. No. 16/418,715 filed May 21, 2019, the entireties which are incorporated by reference herein.

SI module 1210 can provide the predictive model to a model parameter comparator 1212. Model parameter comparator 1212 can perform a peer analysis to determine if the predictive model received from SI module 1210 accurately models the associated system. In some embodiments, model parameter comparator 1212 receives the predictive model from a different controller, device, etc. For example, a user may desire to determine if a predictive model is accurate and provide the predictive model to model parameter comparator 1212 via user device 1106.

Based on the predictive model, model parameter comparator 1212 can perform comparisons and/or other analyses to determine if the predictive model accurately models the system. Specifically, model parameter comparator 1212 may compare model parameters of the predictive model to model parameters of similar predictive models (i.e., comparison models) and/or may compare the model parameters of the predictive model to expected values. In some embodiments, comparing the predictive model to comparison models is advantageous as inaccuracy of any of the predictive models can be identified as opposed to comparing against expected values where accuracy of only the predictive model in question can be verified.

Model parameter comparator 1212 is shown to receive expected values of model parameters from user device 1106 via communications interface 1208. In this way, a user may set the expected values of model parameters based on observations of the user regarding historical dynamics of the system via user device 1106. For example, the user may set an expected value of a model parameter relating to heat disturbance based on an amount of people the user observes in a space the predictive model is associated with (e.g., zone 200). In some embodiments, if expected values are utilized in determining if a zone associated with the predictive model is behaving abnormally, expected values may be extracted from comparison models. In this case, the comparison models may effectively be considered accurate. Expected values based on model parameters of comparison models may be determined by performing various calculations on the model parameters of the comparison models to determine an aggregate value. For example, an expected value of a particular model parameter may be determined by averaging values of the particular model parameter for all comparison models.

In some embodiments, model parameter comparator 1212 receives comparison models and compares model parameters of the predictive model to model parameters of the comparison models. For example, model parameter comparator 1212 can receive comparison models from a database 1218. Database 1218 can be configured to store predictive models for various systems that can be used in a peer analysis process. Database 1218 is shown as a component of peer analysis controller 1102 for sake of example. In some embodiments, database 1218 is separate from peer analysis controller 1102. For example, database 1218 may be a cloud database that peer analysis controller 1102 can access to retrieve predictive models. In some embodiments, model parameter comparator 1212 receives comparison models from other sources. For example, model parameter comparator 1212 can receive predictive models from other controllers, from a cloud database, from user device 1106, etc. As such, database 1218 may be an optional component of memory 1206 depending on a source from which model parameter comparator 1212 receives comparison models.

Based on the expected values of each model parameter and/or the model parameters of the comparison models, model parameter comparator 1212 can determine if model parameters of the predictive model have reasonable valuables and determine whether a system corresponding to the predictive model is behaving normally or abnormally. For example, model parameter comparator 1212 can perform a multivariate outlier analysis with regards to a model parameter of the predictive model to determine if the model parameter is an outlier. To perform the multivariate outlier analysis, model parameter comparator 1212 can utilize the comparison models and the predictive model to generate a set of values of the model parameter. Based on the set of values, the multivariate outlier analysis can be performed to determine if any model parameters of the predictive model or the comparison models are outliers with regards to the other models. In some embodiments, the outlier analysis performed by model parameter comparator 1212 is described in greater detail in U.S. patent application Ser. No. 16/442,103 filed Jun. 14, 2019, the entirety of which is incorporated by reference herein. In some embodiments, the outlier analysis performed by model parameter comparator 1212 is described in greater detail in U.S. patent application Ser. No. 16/512,712 filed Jul. 16, 2019, the entirety of which is incorporated by reference herein. As another example, model parameter comparator 1212 can determine whether the value of the model parameter is within a reasonable range of an expected value of the model parameter. For example, the reasonable range can be ±5% of the expected value, ±10% of the expected value, ±20% of the expected value, within one standard deviation of the median or mean of a set of peer values, etc. Other comparisons and/or analyses that model parameter comparator 1212 can performed are described in greater detail below with reference to FIG. 13.

If model parameter comparator 1212 determines the model parameters of the predictive model are reasonable, model parameter comparator 1212 may determine the predictive model is accurate (and thereby that the corresponding system is behaving normally). If model parameter comparator 1212 determines the predictive model accurately models system dynamics, model parameter comparator 1212 can provide the predictive model to an equipment controller 1214. Based on the predictive model, equipment controller 1214 can generate control signals to provide to HVAC equipment 210 via communications interface 1208. For example, equipment controller 1214 may perform MPC and/or some other control-based application using the predictive model to generate control signals using. In some embodiments, equipment controller 1214 includes some and/or all of the functionality of model predictive controller 414 and/or equipment controller 416 as described with reference to FIG. 4.

In some embodiments, if model parameter comparator 1212 determines the predictive model is slightly inaccurate, model parameter comparator 1212 may nonetheless provide the predictive model to equipment controller 1214. A level of acceptable inaccuracy of predictive models can be defined (e.g., by a user, by peer analysis controller 1102, by an external system, etc.). For example, a user may indicate that predictive models with model parameters within 3%, 5%, 10%, etc. of expected values and/or of model parameters of comparison models are acceptably inaccurate. If the predictive model is only slightly inaccurate (e.g., having an accuracy between an unacceptable inaccuracy threshold and an acceptable inaccuracy threshold), generating control signals based on the predictive model may be advantageous as compared to certain corrective actions (e.g., a full system replacement). Utilizing predictive models that are only slightly inaccurate may reduce costs, reduce overall computer processing, etc. as compared to initiating corrective actions such as replacing building equipment, performing new computationally intensive system identification processes, etc.

In some embodiments, if model parameter comparator 1212 determines the predictive model is only slightly inaccurate due to one or more model parameters being unreasonable, model parameter comparator 1212 may adjust the one or more model parameters to reasonable values. For example, if a model parameter slightly exceeds a maximum threshold, model parameter comparator 1212 may reduce the model parameter to the maximum threshold. In some embodiments, if the predictive model is even slightly inaccurate, model parameter comparator 1212 initiates a corrective action instead of providing the predictive model to equipment controller 1214. In some embodiments, if model parameter comparator 1212 determines the predictive model is even slightly inaccurate, model parameter comparator 1212 initiates a corrective action as compared to adjusting model parameters, generating control signals based on the predictive model, etc.

If model parameter comparator 1212 determines a predictive model does not accurately model system dynamics, model parameter comparator 1212 can provide an inaccurate model notification to a corrective action instruction generator 1216. Based on the inaccurate model notification, corrective action instruction generator 1216 can generate corrective action instructions to address the predictive model inaccuracy and initiate a corrective action. For example, corrective action instruction generator 1216 can generate corrective action instructions to schedule maintenance, perform a new SI experiment, generate a new predictive model, purchase equipment, etc. Corrective action instruction generator 1216 can determine a specific corrective action(s) to initiate based on how inaccurate the predictive model is and/or what model parameters of the predictive model are determined to be unreasonable by model parameter comparator 1212. In other words, corrective action instruction generator 1216 can determine what corrective action(s) to initiate responsive to a relative accuracy of the predictive model and/or what model parameters are determined to be unreasonable. Corrective action instruction generator 1216 can provide corrective action instructions to appropriate devices, systems, controllers, etc. based on what corrective action(s) are determined to be initiated. It should be appreciated that in FIG. 12, corrective action instruction generator 1216 is shown to provide corrective action instructions to user device 1106 and HVAC equipment 210 via communications interface 1208 purely for sake of example. Corrective action instruction generator 1216 can provide corrective action instructions to any relevant entity that can perform a corrective action.

As an example, if some and/or all model parameters are determined to be unreasonable (e.g., the model parameters are twice an expected value, quadruple an expected value, half an expected value, etc.), corrective action instruction generator 1216 may generate corrective action instructions to initiate a more intensive corrective action(s) such as purchasing and replacing building equipment. As another example, if model parameter comparator 1212 determines only one model parameter is unreasonable, corrective action instruction generator 1216 may generate corrective action instructions to initiate a less intensive correction action(s) such as alerting a user regarding inaccuracy of the predictive model. As a more specific example, if model parameter comparator 1212 determines a model parameter associated with an indoor temperature of a space (e.g., zone 200) is inaccurate, corrective action instruction generator 1216 may generate corrective action instructions to initiate a corrective action to adjust where a temperature sensor is positioned in the space as to ensure indoor temperature measurements that are representative of system dynamics are gathered. Corrective action instruction generator 1216 is described in greater detail below with reference to FIG. 14.

In some embodiments, model parameter comparator 1212 provides both an inaccurate model notification to corrective action instruction generator 1216 and provides the predictive model to equipment controller 1214. For example, if model parameter comparator 1212 determines the predictive model is inaccurate, model parameter comparator 1212 may provide the predictive model to equipment controller 1214 for temporary use in MPC and can provide the inaccurate model notification such that corrective action instruction generator 1216 initiates a corrective action to alert a user that the predictive model is inaccurate. Based on said alert, the user can perform an additional action to address the inaccuracy such that the predictive model can be replaced by an updated predictive model.

Referring now to FIG. 13, model parameter comparator 1212 is shown in greater detail, according to some embodiments. Model parameter comparator 1212 is shown to include various components for determining accuracy of predictive models and for determining if model parameters are reasonable. It should be appreciated that the components of model parameter comparator 1212 as shown in FIG. 13 are purely for sake of example. Model parameter comparator 1212 can include more, different, and/or less components than as shown. In some embodiments, some components of model parameter comparator 1212 are part of a single component. Model parameter comparator 1212 can include any appropriate components for determining if a predictive model is accurate.

Model parameter comparator 1212 is shown to receive a predictive model, expected values of model parameters, and comparison models. The predictive model can be analyzed to determine whether the predictive model accurately models system dynamics. The expected values can indicate values that model parameters of the predictive model should be approximately equal to. The comparison models can be other predictive models generated for similar systems. For example, if the predictive model is associated with a warehouse space, the comparison models may be associated with warehouse spaces of similar size, purpose, etc. In some embodiments, model parameter comparator 1212 receives comparison models that model various systems. In this case, model parameter comparator 1212 can determine which models to use for comparison purposes. In some embodiments, the expected values are implicitly indicated by the comparison models.

Model parameter comparator 1212 is shown to include a comparison model selector 1302. Comparison model selector 1302 can select specific models from all received comparison models to utilize in determining an accuracy of the predictive model. The comparison models received may include models that are not useful for comparison purposes and/or are inaccurate themselves. As such, comparison model selector 1302 can parse through each received model to determine what models can be used in comparisons and/or other analyses to determine the accuracy of the predictive model. Comparison model selector 1302 can select comparison models based on various system characteristics described by the comparison models. For example, comparison model selector 1302 may select comparison models that describe systems similar to the system associated with the predictive model based on, for example, building characteristics (e.g., a building location, a building size, a number of floors, a number of rooms, a type of building, etc.), installed building equipment, types of spaces modeled, etc. If, for example, if the predictive model is associated with a space measuring 1000 square feet, model parameter comparator 1212 can select comparison models from the received comparison models that are associated with spaces of similar size (e.g., 900 to 1100 square feet, 800 to 1200 square feet, etc.). Models associated with extremely different sizes (e.g., 10,000 square feet, 100,000 square feet, etc.) may describe significantly different system dynamics and may not include model parameters useful for comparison against model parameters of the predictive model. As such, dissimilar comparison models can be eliminated by comparison model selector 1302 from consideration.

In some embodiments, comparison model selector 1302 determines a similarity metric for each comparison model selected. A similarity metric of a comparison model can indicate how similar a system associated with the comparison model is to the system of the predictive model. For example, a similarity metric may be a value on a one to ten scale such that a value of one can indicate the system of the comparison model is not similar to the system of the predictive model whereas a value of ten can indicate the system of the comparison model is extremely similar to the system of the predictive model. As an example, consider a case where the system associated with the predictive model is a conference room affected by three indoor units (IDUs) of a VRF system. In said example, a comparison model associated with conference room affect by two IDUs may be determined by comparison model selector 1302 to have a high similarity metric (e.g., 8 or 9) whereas a comparison model associated with an office affected by zero IDUs may be determined to have a low similarity metric (e.g., 2 or 3).

Similarity metrics can be utilized by components of model parameter comparator 1212 in determining accuracy of the predictive model. In particular, model parameters of comparison models with high similarity metric values can be weighted more heavily as compared to model parameters of comparison models with low similarity metric values. Utilizing the similarity metrics can allow for comparison models for systems similar to that of the system associated with the predictive model to be prioritized over less similar comparison models. In some embodiments, comparison model selector 1302 eliminates comparison models that do not meet a threshold similarity metric value from consideration. For example, comparison model selector 1302 may eliminate any comparison models with a similarity metric value less than five to ensure only comparison models closely related to the predictive model are used in peer analysis. Further, if expected values are generated based on the comparison models, the similarity metrics can likewise be applied to the expected values.

Model parameter comparator 1212 is also shown to include a threshold value calculator 1304. Threshold value calculator 1304 can calculate threshold values of model parameters used to determine if model parameters of the predictive model are reasonable. Threshold values can indicate maximum and/or minimum values of model parameter that can be considered reasonable by model parameter comparator 1212. To calculate the threshold values, threshold value calculator 1304 can utilize the comparison models selected by comparison model selector 1302 and/or can utilize received expected values to determine a base value of a model parameter used for comparison purposes. The base value can be an average of all values of the model parameter for each comparison model, a mean value, the expected value itself, etc. Threshold value calculator 1304 can calculate a range of values that are reasonable using the base value. For example, threshold value calculator 1304 can define a range of reasonable values for a model parameter as plus or minus five percent of the base value, plus or minus ten percent of the base value, plus or minus fifteen percent of the base value, plus or minus twenty percent of the base value, within one standard deviation of the median or mean of a set of peer values. If a value of the model parameter of the predictive model is within said range, the model parameter can be determined by threshold value calculator 1304 to be reasonable. If the value is outside said range, the model parameter can be determined to be unreasonable.

In some embodiments, threshold value calculator 1304 determines a magnitude of how much unreasonable model parameters differ from ranges of reasonable values. As a value of a model parameter moves away from a range of reasonable values, the magnitude may increase. As the magnitude increases, the model parameter may be determined to be more unreasonable, thereby indicating greater inaccuracy of the predictive model. Magnitudes and weights of model parameters are described in greater detail above with reference to FIG. 11.

Still referring to FIG. 13, model parameter comparator 1212 is shown to include a multivariate outlier detector 1306. Based on comparison models selected by comparison model selector 1302 and/or received expected values, multivariate outlier detector 1306 can identify outlier model parameters of the predictive model by performing a multivariate outlier detection process. If the multivariate outlier detection process identifies a model parameter of the predictive model (or other comparison models) as an outlier, the model parameter can be flagged as being unreasonable, thereby indicating the predictive model may not be accurate. Accuracy of the predictive model can be estimated based on how many model parameters are detected as outliers. In some embodiments, multivariate outlier detector 1306 performs a univariate outlier analysis. In some embodiments, multivariate outlier detector 1306 may be operable in concert with systems and methods described in U.S. patent application Ser. No. 16/442,103 filed Jun. 14, 2019 and/or U.S. patent application Ser. No. 16/512,712 filed Jul. 16, 2019, both of which are incorporated by reference herein in their entireties.

Model parameter comparator 1212 is shown to include an MPC behavior comparator 1308. In some embodiments, outputs of MPC and/or other control-based applications are used to determine accuracy of the predictive model. MPC behavior comparator 1308 can pass experimental data and/or measured data (e.g., weather data, operating conditions, etc.) through the predictive model and the comparison models to gather outputs such as operating setpoints of building equipment (e.g., HVAC equipment 210). If MPC behavior comparator 1308 determines the outputs of the predictive model and the comparison models are sufficiently similar, MPC behavior comparator 1308 may determine the predictive model is accurate. For example, if an average temperature setpoint calculated by passing the data through the comparison models is 75° F., the predictive model can be determined to be accurate if the predictive model generates a temperature setpoint between 73° F.-77° F. In other words, if the predictive model generates values of output variables similar to those of the comparison models, the model parameters may be determined to be reasonable. If the values of the output variables generated based on the predictive models are not similar to those of the comparison models, one or more model parameters may be determined to be unreasonable.

Model parameter comparator 1212 is also shown to include a model parameter adjuster 1310. Model parameter adjuster 1310 can allow model parameter comparator 1212 to adjust values of particular model parameters of the predictive model if the model parameters are unreasonable. If a model parameter is only slightly unreasonable (e.g., the model parameter is one percent of an expected value above a maximum threshold), it may be more computationally expensive and/or may incur more costs to perform an intensive corrective action (e.g., retraining the model, purchasing new building equipment, etc.) as opposed to utilizing the predictive model. As such, model parameter adjuster 1310 can adjust the value of the model parameter to move the value closer to an expected value and/or within an expected range. In some embodiments, model parameter adjuster 1310 only adjusts values of model parameters determined to be non-critical to model outputs. In other words, model parameter adjuster 1310 may only adjust values of model parameters that do not have a large impact on predictive model outputs. By adjusting values of model parameters, model parameter adjuster 1310 can reduce overall computational complexity and/or reduce overall costs by not initiating certain corrective actions if a model parameter is slightly unreasonable.

Referring now to FIG. 14, corrective action instruction generator 1216 is shown in greater detail, according to some embodiments. Corrective action instruction generator 1216 is shown to include various components for initiating corrective actions by generating corrective action instructions to be provided to appropriate devices, systems, controllers, etc. Corrective action instruction generator 1216 can generate corrective action instructions that can describe a corrective action to initiate. For example, corrective action instructions can include details for performing an equipment purchase. The corrective action instructions indicating the equipment purchase can be provided to an equipment purchasing system such that new equipment can be purchased for a building (e.g., building 10). In this way, corrective action instruction generator 1216 can initiate a corrective action of purchasing the new equipment by generating and providing the corrective action instructions to the equipment purchasing system.

In some embodiments, corrective actions have associated sub-actions. A sub-action can include smaller actions that, when combined in part or in whole, result in performance of the corrective action. As such, components of corrective action instruction generator 1216 may generate corrective action instructions that indicate a corrective action and/or sub-actions for the corrective action. It should be appreciated that the components of corrective action instruction generator 1216 as shown in FIG. 14 are purely for sake of example. Corrective action instruction generator 1216 can include more, different, and/or less components than as shown. In some embodiments, some components of corrective action instruction generator 1216 are part of a single component. Corrective action instruction generator 1216 can include components for initiating any type of corrective action that can be taken in response to a determination that a predictive model is inaccurate.

Corrective action instruction generator 1216 is shown to include an alert generator 1402. Alert generator 1402 can generate corrective action instructions indicating an alert to be provided to a user. In some embodiments, the alert includes information such as what predictive model is determined to be inaccurate (e.g., a predictive model associated with a timestamp when the predictive model was generated), recommended actions that can be taken as a result of the predictive model inaccuracy, etc. The alert can be provided to a user device of a user (e.g., user device 1106 as described with reference to FIGS. 11 and 12). In this way, the user can be made aware of the predictive model inaccuracy and can determine what, if any, further actions to take. Alert generator 1402 can facilitate initiation of a less intensive corrective action as alerting a user to predictive model inaccuracy may not require significant computational resources and does not necessitate a significant economic expenditure. Further, the corrective action of alerting the user to predictive model inaccuracy can provide the user with more control over addressing the inaccuracy as compared to other automatic corrective actions.

Corrective action instruction generator 1216 is also shown to include a system identification experiment generator 1404. SI experiment generator 1404 can generate corrective action instructions that can initiate a corrective action for performing a new SI experiment. If the predictive model is determined to be inaccurate, the predictive model may have been generated using training data unrepresentative of current system dynamics. For example, if the training data was gathered prior to new building equipment being installed for a space (e.g., zone 200), the training data may not capture changes in system dynamics as a result of the new building equipment. To mitigate effects of unrepresentative training data on the predictive model, the new SI experiment can result in new training data being gathered by operating building equipment (e.g., HVAC equipment 210) and measuring various data points (e.g., outdoor/indoor air temperature, operating setpoints for the building equipment, etc.). Based on the measured data points, the predictive model can be updated (e.g., retrained) and/or a new predictive model can be generated. As a result of the SI experiment initiated by SI experiment generator 1404, the new/updated predictive model can capture more up-to-date system dynamics and may more accurately model the system.

Corrective action instruction generator 1216 is also shown to include a maintenance scheduler 1406. Maintenance scheduler 1406 can generate corrective action instructions that initiate a corrective action of scheduling maintenance activities to be performed on building equipment (e.g., HVAC equipment 210). Maintenance activities can include updating/maintaining existing building equipment to improve functioning of the existing building equipment. For example, maintenance activities can include activities such as cleaning filters, unclogging pipes, recharging refrigerant, etc. As a result of the maintenance activities, a degradation state of the building equipment can be improved (e.g., reduced) such that overall operating efficiency of the building equipment can improve. If the predictive model inaccuracy results from the degradation state of the building equipment being higher than that of systems associated with comparison models, performing maintenance on the building equipment can mitigate effects of the degradation state on accuracy of the predictive model.

Maintenance can be scheduled for the building equipment in different ways. For example, the corrective action instructions indicating what maintenance activities should be performed can be provided to a maintenance scheduling system. In this case, the maintenance scheduling system can determine a time to perform the maintenance, a maintenance provider to perform the maintenance, etc. As another example, maintenance scheduler 1406 can generate corrective action instructions that are provided directly to a maintenance provider indicating the maintenance activity to be performed.

Still referring to FIG. 14, corrective action instruction generator 1216 is shown to include an equipment purchaser 1408. Equipment purchaser 1408 can generate corrective action instructions to initiate a corrective action of purchasing new building equipment. In some embodiments, the predictive model inaccuracy results from existing building equipment malfunctioning, operating inefficiently, having fewer control options (e.g., a heater operating in an on/off mode as compared to operating based on a setpoint value), etc. New building equipment may have more reliable effects on environmental conditions as compared to heavily degraded building equipment. For example, if an IDU has a high degradation state, it may not impart airflow to a space (e.g., zone 200) as may otherwise be expected due to faulty components such malfunctioning fans or clogged vents. Degraded building equipment can therefore result environmental changes not representative of system dynamics under standard operating conditions, thereby affecting accuracy of predictive models generated based on data gathered based on operation of the degraded building equipment. Equipment purchaser 1408 can thereby initiate a corrective action of purchasing new equipment to replace and/or be installed alongside existing building equipment as to improve reliability of measured system dynamics.

Corrective action instruction generator 1216 is also shown to include an equipment control generator 1410. By incorporating equipment control generator 1410, corrective action instruction generator 1216 can generate corrective action instructions that relate to operation of building equipment (e.g., HVAC equipment 210). For example, if a predictive model is determined to be inaccurate, equipment control generator 1410 may initiate a corrective action of temporarily disabling particular building devices that are identified to be malfunctioning and may be impacting accuracy of the predictive model. Based on said corrective action, the predictive model can be re-identified to determine if the particular building devices are impacting predictive model accuracy. In some embodiments, corrective action instructions generated by equipment control generator 1410 are provided to equipment controller 1214 as described with reference to FIG. 12.

Corrective action instruction generator 1216 is also shown to include a comparison model updater 1412. Comparison model updater 1412 can generate corrective action instructions that can initiate a corrective action of updating comparison models utilized by model parameter comparator 1212 as described with reference to FIGS. 12 and 13. If, for example, model parameter comparator 1212 is using old comparison models, the predictive model may be incorrectly flagged as inaccurate. As such, it may be beneficial to reevaluate what comparison models are being used to determine accuracy of the predictive model. If the comparison models used as a basis for comparison are determined by comparison model updater 1412 to have low applicability to the predictive model in question (e.g., due to an age of the comparison models), comparison model updater 1412 can initiate a corrective action to update a set of comparison models. The corrective action can include various sub-actions such as requesting additional comparison models from a central repository and/or other systems, purging comparison models that are not useful for comparisons and/or other analyses for the predictive model, etc. Comparison model updater 1412 can improve the set of comparison models to ensure that the model parameters of the predictive model are properly evaluated.

### Process for Performing Peer Analysis of Predictive Models

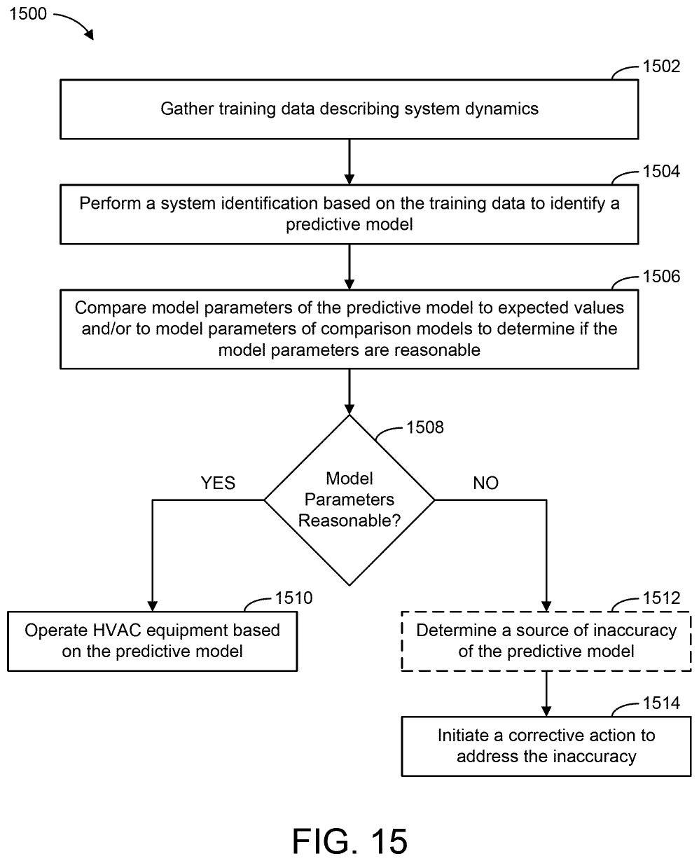

Referring now to FIG. 15, a process 1500 for performing a peer analysis to determine if a predictive model is accurate is shown, according to some embodiments. Process 1500 can compare model parameters of the predictive model to expected values to determine if the model parameters are reasonable. If the model parameters are reasonable, the predictive model may be determined to be accurate and suitable for use in control-based applications such as MPC. If the model parameters are not reasonable, the predictive model may not be accurate. If the predictive model is determined to not be accurate, a corrective action can be initiated to address the predictive model inaccuracy. In some embodiments, some and/or all steps of process 1500 are performed by peer analysis controller 1102 and/or components therein as described with reference to FIGS. 11-14.

Process 1500 is shown to include gathering training data describing system dynamics (step 1502). The training data can be gathered by operating building equipment to affect conditions in a space of a building. The training data can also be gathered by measuring environmental conditions such as air temperature, relative humidity, air quality, etc. of indoor and/or outdoor spaces. The training data can be gathered over some predetermined amount of time (e.g., a week, a month, etc.) such that a data capturing true system dynamics can be captured. If the amount of time is too short, the training data may not include an adequate amount of HVAC excitations and other critical data that results in generation of a predictive model representative of the system. In some embodiments, step 1502 is performed by SI module 1210.

Process 1500 is shown to include performing a system identification process based on the training data to identify a predictive model (step 1504). By identifying the predictive model based on the training data, the predictive model can capture dynamics inherently described by the training data. For example, the training data may describe an amount of time it takes a temperature of the space to change from a first temperature to a second temperature based on operation of the building equipment. In this way, model parameters can be identified to capture said amount of time. However, if the training data is not representative of true system dynamics, the predictive model may be inaccurate. As such, determining accuracy of the predictive model may be necessary to ensure inaccurate predictive models are not utilized in control-based applications. In some embodiments, step 1504 is performed by SI module 1210.

Process 1500 is shown to include comparing model parameters of the predictive model to expected values and/or to model parameters of comparison models to determine if the model parameters are reasonable (step 1506). If the model parameters are reasonable, the predictive model may be determined to accurately model system dynamics, thereby indicating an associated system is behaving normally. If the model parameters are not reasonable, the predictive model may be determined to not accurately system dynamics, thereby indicating that the associated system is behaving abnormally. If the expected values are utilized in the comparison, the expected values can be received from a user, extracted from the comparison models that describe systems similar to that of the predictive model, estimated based on known system dynamics, etc. To perform the comparison, step 1506 can include performing various analyses/comparisons between the predictive model and expected values and/or the predictive model and the comparison models. For example, step 1506 may include performing a multivariate outlier analysis on model parameters of the predictive model and the comparison models, performing other outlier analyses, determining if values of the model parameters exist within a predetermined range of an expected value of each model parameter, analyzing outputs of MPC based on the predictive model and comparison models, etc. It should be noted that if step 1506 includes comparing model parameters of the predictive model to model parameters of the comparison models, step 1506 may include determining whether any of the predictive models (i.e., the predictive model or the comparison models) are associated with reasonable values. In this way, process 1500 may include analyzing accuracy and reasonableness of multiple predictive models as opposed to only the predictive model in question. In some embodiments, step 1506 is performed by model parameter comparator 1212.

Process 1500 is shown to include a determination regarding if the model parameters of the predictive model are reasonable (step 1508). Step 1508 can be based on the comparison performed in step 1506. Accordingly, step 1508 may include determining if model parameters of the predictive model are reasonable and/or determining if model parameters of the comparison models are reasonable. In other words, if step 1506 includes comparing the predictive model to comparison models, step 1508 (and subsequent steps in process 1500) may be performed multiple times for each model. However, if step 1506 includes comparing model parameters of the predictive model to expected values (or if the comparison models are otherwise not of interest even if they are identified as inaccurate/unreasonable), step 1508 may only be performed for the predictive model identified in step 1504. If a determination is made that the model parameters are reasonable (step 1508, “YES”), process 1500 can continue to step 1510. If a determination is made that the model parameters are not reasonable (step 1508, “NO”), process 1500 can proceed to step 1512. In some embodiments, step 1508 is performed by model parameter comparator 1212.

Process 1500 is shown to include operating HVAC equipment based on the predictive model (step 1510). If step 1510 is performed, the predictive model may be suitable for use in control-based applications such as MPC. As such, the predictive model can be used as a basis for control decisions for the HVAC equipment. In some embodiments, step 1510 includes utilizing the predictive model in other uses. For example, step 1510 may include providing the predictive model to a central model repository (e.g., a cloud repository) as a new comparison model. As the predictive model should accurately model system dynamics if step 1510 is performed, the predictive model can be used to determine if future predictive models accurately model system dynamics for similar systems as the system modeled by the predictive model. In this way, the predictive model can be reused to determine accuracy of other predictive models. In some embodiments, step 1510 is performed by equipment controller 1214 and/or other components of peer analysis controller 1102.

Process 1500 is shown to include determining a source of inaccuracy of the predictive model (step 1512). Step 1512 is shown as an optional step in process 1500 as determining the source of the inaccuracy may not always be possible depending on how the predictive model is used, what model parameters are identified as unreasonable, etc. For example, a model parameter associated with a heat disturbance affecting a space may be inaccurate for various reasons such as a faulty and/or poorly positioned temperature sensor, an insufficient amount of data being gathered, unrepresentative data being used to generate the predictive model, etc. As such, determining a specific source of the inaccuracy may not be possible. However, if possible, identifying the source of the inaccuracy can aid in determining what corrective action(s) to initiate in order to address the inaccuracy. For example, if a model parameter associated with a resistance between indoor air and outdoor air is unreasonable, the source of the inaccuracy of the predictive model may be determined to be incorrect measurements of an insulation factor of a wall. As such, an appropriate corrective action to initiate may be to instruct a user to re-measure the insulation factor. In some embodiments, step 1512 is performed by model parameter comparator 1212 and/or corrective action instruction generator 1216.

Process 1500 is shown to include initiating a corrective action to address the inaccuracy (step 1514). In some embodiments, if step 1512 is performed and results in a determination of a source of the inaccuracy, the corrective action is based on the determined source. The corrective action can be initiated by generating corrective action instructions and providing the corrective action instructions to an appropriate device, system, controller, user, etc. The corrective action can be any action that addresses the inaccuracy. For example, the corrective action can include alerting a user to the inaccuracy, retraining the predictive model, performing a new SI experiment, performing maintenance and/or replacing building equipment, disabling certain building devices, etc. In some embodiments, step 1514 includes initiating multiple corrective actions. If multiple corrective actions are initiated, each corrective action may be independent of other corrective actions or may be associated with other corrective actions. For example, performing a new SI experiment may be independent of other corrective actions whereas corrective actions for scheduling a maintenance to be performed and purchasing components for replacement may be associated with an overall corrective action of improving operation of building equipment. In some embodiments, step 1514 is performed by corrective action instruction generator 1216.

### Configuration of Exemplary Embodiments

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, calculation steps, processing steps, comparison steps, and decision steps.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations. The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Wwhat is claimed is:

1. A controller for performing a peer analysis of predictive models for a building, the controller comprising:
one or more processors; and
one or more non-transitory computer-readable media storing instructions that, when executed by the one or more processors, cause the one or more processors to perform operations comprising:
comparing model parameters of a set of predictive models corresponding to a set of building zones, the model parameters indicating system dynamics of the building zones, to determine whether any of the building zones are exhibiting abnormal system dynamics; and
initiating a corrective action in response to determining that at least one of the building zones is exhibiting abnormal system dynamics.

2. The controller of claim 1, wherein initiating the corrective action comprises:
determining whether a source of abnormal system dynamics of the at least one zone can be identified in at least one predictive model of the set of predictive models; and
in response to a determination that the source of abnormal system dynamics of the at least one zone can be identified in the at least one predictive model, identifying the source of abnormal system dynamics;
wherein the corrective action is selected based on the source of abnormal system dynamics.

3. The controller of claim 1, wherein the set of predictive models is generated using a system identification process based on training data to identify predictive models.

4. The controller of claim 1, wherein comparing model parameters of the set of predictive models comprises at least one of:
performing a multivariate outlier analysis on the model parameters; or
determining whether the model parameters adhere to a threshold value based on a second building with similar characteristics to the building.

5. The controller of claim 1, wherein initiating the corrective action comprises:
determining the corrective action based on which of the system dynamics are associated with the model parameters;
generating corrective action instructions indicating how to perform the corrective action; and
initiating the corrective action by providing the corrective action instructions to one or more entities.

6. The controller of claim 1, wherein the controller further comprises a database configured to store a plurality of predictive models for a plurality of buildings or a plurality of building spaces, wherein the operations further include querying the database to obtain the set of predictive models.

7. The controller of claim 1, wherein the corrective action comprises at least one of:
providing an alert to a user;
scheduling a maintenance activity for building equipment;
purchasing new building equipment;
generating control actions for the building equipment; or
initiating a system identification experiment to gather training data.

8. A method for performing a peer analysis of predictive models for a building, the method comprising:
comparing model parameters of a set of predictive models corresponding to a set of building zones, the model parameters indicating system dynamics of the building zones, to determine whether any of the building zones are exhibiting abnormal system dynamics; and
initiating a corrective action in response to determining that at least one of the building zones is exhibiting abnormal system dynamics.

9. The method of claim 8, wherein initiating the corrective action comprises:
determining whether a source of abnormal system dynamics of the at least one zone can be identified in at least one predictive model of the set of predictive models; and
in response to a determination that the source of abnormal system dynamics of the at least one zone can be identified in the at least one predictive model, identifying the source of abnormal system dynamics;
wherein the corrective action is selected based on the source of abnormal system dynamics.

10. The method of claim 8, wherein the set of predictive models is generated using a system identification process based on training data to identify predictive models.

11. The method of claim 8, wherein comparing model parameters of the set of predictive models comprises at least one of:
performing a multivariate outlier analysis on the model parameters; or
determining whether the model parameters adhere to a threshold value based on a second building with similar characteristics to the building.

12. The method of claim 8, wherein initiating the corrective action comprises:
determining the corrective action based on which of the system dynamics are associated with the model parameters;
generating corrective action instructions indicating how to perform the corrective action; and
initiating the corrective action by providing the corrective action instructions to one or more entities.

13. The method of claim 8, further comprising querying a database to obtain the set of predictive models, the database storing a plurality of predictive models for a plurality of buildings or a plurality of building spaces.

14. The method of claim 8, wherein the corrective action comprises at least one of:
providing an alert to a user;
scheduling a maintenance activity for building equipment;
purchasing new building equipment;
generating control actions for the building equipment; or
initiating a system identification experiment to gather training data.

15. An environmental control system for a building, the system comprising:
building equipment that operates to affect a variable state or condition of the building; and
a controller comprising a processing circuit configured to perform operations comprising:
comparing model parameters of a set of predictive models corresponding to a set of building zones, the model parameters indicating system dynamics of the building zones, to determine whether any of the building zones are exhibiting abnormal system dynamics; and
initiating a corrective action in response to determining that at least one of the building zones is exhibiting abnormal system dynamics.

16. The system of claim 15, wherein initiating the corrective action comprises:
determining whether a source of abnormal system dynamics of the at least one zone can be identified in at least one predictive model of the set of predictive models; and
in response to a determination that the source of abnormal system dynamics of the at least one zone can be identified in the at least one predictive model, identifying the source of abnormal system dynamics;
wherein the corrective action is selected based on the source of abnormal system dynamics.

17. The system of claim 15, wherein the set of predictive models is generated using a system identification process based on training data to identify predictive models.

18. The system of claim 15, wherein comparing model parameters of the set of predictive models comprises at least one of:
performing a multivariate outlier analysis on the model parameters; or
determining whether the model parameters adhere to a threshold value based on a second building with similar characteristics to the building.

19. The system of claim 15, wherein initiating the corrective action comprises:
determining the corrective action based on which of the system dynamics are associated with the model parameters;
generating corrective action instructions indicating how to perform the corrective action; and
initiating the corrective action by providing the corrective action instructions to one or more entities.

20. The system of claim 15, wherein the corrective action comprises at least one of:
providing an alert to a user;
scheduling a maintenance activity for building equipment;
purchasing new building equipment;
generating control actions for the building equipment; or
initiating a system identification experiment to gather training data.
